(19) United States
(12) Patent Application Publication
(10) Pub. No.: US 2007/0169006 A1
(43) Pub. Date: Jul. 19, 2007

(54) Software generation method

(76) Inventor: Osamu Arai, Tokyo (JP)

Correspondence Address: WILMER CUTLER PICKERING HALE AND DORR LLP, 1875 PENNSYLVANIA AVE., NW, WASHINGTON, DC, 20004, US

(21) Appl. No.: 10/574,703

(22) PCT Filed:
(86) PCT No.: PCT/IB04/03266

(30) Foreign Application Priority Data
Oct. 6, 2003 (JP) 2003-346442

(51) Int. Cl. G06F 9/45; G06F 9/44

(52) U.S. Cl. 717/136; 717/106

(57) ABSTRACT

In a system comprising a program of word units, processing of the word unit program for generating output data is completed within a minimum number of execution times by avoiding useless iteration. According to the present invention, a route operation element is regarded as one word, and requirements are defined as a word unit program which defines a relation among words. The route operation element is removed by setting definition equation execution conditions of the route operation element as definition equation execution conditions of words belonging to a basic structure specified by the route operation element when the conditions are established, and structures of the entire system are integrated into one. For an integrated word unit program group (not including the route operation element) of the entire system thus obtained, topological sort is carried out to rearrange word unit program groups in an optimal order. Thus, for example, useless iteration can be prevented.

### TECHNICAL FIELD

The present invention relates to a software generation method based on a mathematical way of thinking, and more particularly to a software generation method which uses an adjacency matrix and topological sort for Lyee methodology.

### BACKGROUND ART

(1) Problems of Software Development

Easy and quick manufacturing of high-quality software is a basic concern in a software development and research field. Various methodologies and technologies have been invented and proposed to improve productivity, maintenance efficiency, and quality of software developments. However, none have been able to achieve such tasks. One of the reasons is that software itself is complex and difficult to be understood. Another reason is a limit on a current methodology. In fact, almost all methodologies that have been proposed have not failed to manufacture clearly understood and modifiable systems, and they are still considered to be for use by specialists who have a very wide range of skills and technical knowledge and know-how. Thus, labor and maintenance costs become high, and extensive checks are necessary to be executed on software. Outlines and problems of conventional software development method are summarized as follows.

(2) Procedural Programming

Generally, procedural programming has been effective in development and implementation of business systems because of easy handling of its descriptive language. However, important problems still remain to be solved, such as a difficulty of accurate implementation of requirements, productivity, and maintenance.

(3) Declarative Programming

Meanwhile, declarative programming, a programming of making declarations which is requirement definition itself, has been used in an application field of a noncalculation type such as logical reasoning, inference and user intelligence gathering of artificial intelligence or an expert system. The declarative programming is a method not to describe control procedure, but to declare relations between data defined in requirements. As its programming is executed based on the declaration, an advantage of the declarative programming is that the requirements can be accurately implemented while the procedural programming requires to explicitly specify procedure such as control procedure.

However, even in the declarative programming, there is a problem that performance of software in running is not good because of execution control structures. There is also a disadvantage that it is difficult to learn a good command of languages for the declarative programming. As languages for the declarative programming, there are a logical programming language (e.g., PROLOG) which uses a logical equation, and a functional programming language (e.g., LISP) which describes a target state as a mathematical function. No value is generated only by a declaration. To generate a value, therefore, a declarative language has a procedural logical mechanism to execute the declaration. Such a procedural logical mechanism has many conditions to enable execution of all types of declarations, which requires knowledge of mathematics and logic, and thus its use is difficult. Accordingly, the declarative language has not been in widespread use. This is why the procedural programming language by a procedural language which has a structure close to that of a natural human language has been in widespread.

(4) Object Oriented Programming

We have object oriented programming, which is a programming technique for integrating data and an operation procedure (called method) into a module called a object, and describing a program as a combination of objects. The program comprises highly independent modules called objects. Thus, this programming provides advantages that range of influences caused by changes/modifications is limited, easy re-use of each object, and the like.

However, there are no strict rules on what range has to be one object to implement requirements, and how components are combined, and no regulations on an execution order such as a structured design approach. In an actual development field, relations between objects are not applied with complete consistency. In many cases, even if great many objects are produced as a result of developments, nobody except creators themselves understands the objects. In other words, completed software becomes a group of functions of no regularities, and has a strong tendency that it is finally difficult to decompose and reuse them.

[Patent Document 1]

Pamphlet of International Publication No. 97-16784

[Patent Document 2]

Pamphlet of International Publication No. 89-19232

[Patent Document 3]

Pamphlet of International Publication No. 99-49387

[Patent Document 4]

Pamphlet of International Publication No. 00-79385

[Patent Document 5]

Pamphlet of International Publication No. 02-42904

[Patent Document 6]

Pamphlet of International Publication No. 2004-68342

[Patent Document 7]

Publication of Japanese Patent Application Laid-Open No. 2002-202883

[Nonpatent Document 1]

“The Formal Semantics of Programming Languages” by Glynn Winskel, the MIT Press, 1993

[Nonpatent Document 2]

“Semantics with Applications; A Formal Introduction” by Hanne Riis Neilson, and Fleming Neilson, John Wiley & Sons, 1992

[Nonpatent Document 3]

“Principle of Lyee Software” by Fumio Negoro, pp. 441 to 446, Proceedings of 2000 International Conference on Information Society in the 21st Century (IS2000), Aizu, Japan, Nov. 5 to 8, 2000

[Nonpatent Document 4]

“Intent Operationalisation for Source Code Generation” by Fumio Negoro, The 5th World Multi-Conference on Systemics, Cybernetics and Informatics (SCI 2001), Orland, US, Jul. 22 to 25, 2001

### DISCLOSURE OF THE INVENTION

### Problems to be Solved by the Invention

(1) Lyee Development Methodology

Recently, there has been proposed a new and very promising methodology called Lyee (tail-character word of “governmentaL methodologY for softwarE providencE”, read as “lee”, and invented by Fumio Negoro). The Lyee is a new method of automatically developing software from requirements.

In the case of the Lyee methodology, while it is a declarative type, no special logical mechanism is necessary to execute declarations, and the execution of the declarations is a procedure of simple value substitution as in the case of the procedural programming. Accordingly, a language to be used can be generally used procedural languages. In other words, the Lyee methodology has advantages of both of a declarative type which enables accurate implementation of requirements and a procedural type which can be written by procedural languages of easy description.

For an outline of the Lyee development method, Patent Application No. 2004-27240 by the applicant of the present invention, and the Patent Document 6 will be quoted, and regarded as parts of the disclosure. The outline is as follows.

(2) Declaration in Lyee Methodology

According to the Lyee methodology, an abstraction target to be declared is a variable. A declared variable is called a word according to the Lyee methodology. Generally, declarative specifications mean that abstracted unit to be declared can written in any order, and the units are described using an equation, and there is bi-directionality from a right side to a left side, and from the left side to the right side. According to the Lyee methodology, however, there is no bi-directionality while descriptive ordality of words is removed. Thus, a framework is simple.

Main components of a word declaration are a word name, a definition equation, calculation conditions of the definition equation, input/output attributes, value attributes, and the like. The definition equation is a relation equation showing a relation with other words. For example, a word a can be declared by a definition equation a=b+c. For execution of this declaration, the relational equation only needs to be executed as a substitution equation. For example, to execute the declaration of word a, a=b+c, (to obtain a value of a), it is only needed to substitute values for the variables b and c on the right side of a.

(3) Mechanism for Executing Declaration within Framework of Procedural Type

It is a fixed program structure provided by the Lyee methodology that realizes orderless description of declarations while it is implemented in a framework of procedural languages. As long as a computer for processing a program is a currently used von Neumann type which sequentially processes commands, in the case of the procedural language, a problem of order must be solved in some way. In the case of the other declarative programming methods, it is solved by declarative language. According to the Lyee methodology that uses the procedural language, the problem of order is solved by the program structure.

The program structure comprises modules of fixed structures for executing declarations of word units (called “declaration execution modules” hereinafter). These modules are grouped into a unit called a palette. In the palette, any any order can be employed to execute the declaration execution modules. An execution control module controls execution of the declaration execution modules to be repeated until execution of all the execution modules in the palette is completed (i.e., until values are generated).

The palettes are a W02 palette for executing declarations of input words, a W03 palette for executing calculation conditions in declarations of output words, and a W04 palette for executing definition equations and outputs in the declarations of the output words. A set of these three kinds of palettes constitutes a collective unit called a basic structure. That is, a program of Lyee structure employs a structure that it is divided into basic structure units, the basic structure is divided into three kinds of palettes, and each palette is divided into declaration execution modules. The basic structure is made for each output logical record (i.e., a group of words simultaneously output to the same medium). A process route diagram (PRD) shows this division of structure of the Lyee program.

The entire program of the Lyee methodology comprises the declaration execution modules of fixed structures for executing the declaration of word units. Besides, a method of constituting the entire program of those declaration execution modules has been fixed. Accordingly, a program can be automatically generated by substituting requirements of word units for the declaration execution modules of the fixed structures.

In reality, automatic generation of a program by the Lyee methodology is realized by a tool called “LyeeALL”. The LyeeALL is a tool for constructing one program by automatically substituting a declaration of requirements in given blank sections of codes of the declaration execution modules of the fixed structures (called “template” meaning a form), and constituting the declaration execution modules according to the given rule.

In software developments based on the Lyee methodology, engineers are divided into two groups, and respectively carry out two kinds of specialized work. One team is skilled in an external environment, such as OS, middleware or database, in which the program of the Lyee structure is executed, and they set parameters of each external environment in the templates of the Lyee structure program. The other team defines user requirements, and declares the requirements according to the Lyee methodology to implement the requirements in the templates of the Lyee structure. As developments based on such a division system of labor are available, in the developments based on the Lyee methodology, all programmers do not need to have a wide range of skills concerning the external environments, and a problem of a shortage of workers with such skills can be solved.

(4) Problems of Conventional Lyee Structure

As described above, the Lyee methodology has great advantages of accurate implementation of the requirements, automatic code generation, easy maintenance, and the like. However, there are problems in the iteration and divided structures. It is said that an execution speed is low because of the iteration processing and that a program size is large because of the divided structures.

On the other hand, according to the Lyee methodology, the requirements are divided into units called basic structures to implement specifications. Explicit information regarding execution orders such as screen transitions, key relations of database or the like are captured by a group of words (record), and an execution condition of the words belonging to the group are collectively recognized. In the current Lyee structure, since these divided structures are directly formed into codes, the program size is large, and the execution speed is low.

It is an important task to improve the Lyee structure into a program of no unnecessary iteration, a smaller size, and an efficient processing speed while maintaining its declarative programming advantages and requirement meanings without any changes.

As a method of improving the execution speed by eliminating the unnecessary iteration, there has been proposed a method of automatically optimizing an order of declaration execution modules (ordering to complete declaration execution by one round) by topological sort (PCT/JP 03/09591). By applying topological sort to modules in a palette, it is possible to avoid useless iteration in the palette.

However, there is a limit on effects if only the topological sort is applied while the framework of the Lyee divided structures is maintained. It is because there are also iterations between the palettes and between the basic structures, and generation of all values is not completed by one round even while the number of iteration times is reduced to a minimum by the optimal ordering in the palette by the topological sort. Additionally, the divided structures themselves cause an increase in program size.

Thus, to bring greater solutions to the problems of the size and the processing speed of the Lyee program having the iteration and divided structures, it may be effective not to divide into units called the palettes and the basic structures and to apply topological sort to declaration execution modules in a range of requirements implemented as one program.

The present invention relates to a method of applying topological sort to an entire program by eliminating the divided structures of the conventional Lyee structure. Its object is, therefore, to improve a software execution speed and a program size based on the Lyee methodology.

### MEANS FOR SOLVING THE PROBLEM

To achieve the object of the present invention, a software generation method comprises: a first step for defining a statement execution unit of any of L2 processing (checking process for input word's attribute), L processing (value generation processing of output word), I2 processing (logical body input processing), and O4 processing (logical body output processing), all of which are necessary for satisfying the requirements, from word-unit statements in which the user requirements to be implemented as a program is declared by a word name, a definition equation, execution conditions of the definition equation, input/output attributes, and attributes of a word value for each logical body accompanied by access conditions and for each word on the logical body; a second step for defining a (partial) order relation of all the defined L2 processing (checking process for input word's attribute), L processing (value generation processing of output word), I2 processing (logical body input processing), and O4 processing (logical body output processing); a third step for executing topological sort for the L2 processing, L processing, I2 processing, and O4 processing defined in the (partial) order relation defined in the second step; and a fourth step for arranging a predetermined code sequence based on Lyee methodology and relevant to the statement execution unit in accordance with an order of the statement execution units rearranged in the third step.

According to the present invention thus constructed, a program is created to execute the statement of word units defined in the first step by units of the L2 processing (checking process for input word's attribute), the L processing (value generation processing of output word), the I2 processing (logical body input processing), and the O4 processing (logical body output processing) in a shortest order, whereby software generation using the Lyee methodology becomes more efficient. In other words, since all the functions of the steps can be automated, it is possible after all to automate a process consistently from elimination of iteration processing to software generation. Thus, a software production speed and efficiency can be greatly improved.

Here, “definition of (partial) order relation among all the L2 processing (checking process for input word's attribute), L processing (value generation processing of output word), I2 processing (logical body input processing), and O4 processing (logical body output processing)” means that the order relation among them is represented by, for example, a directed graph by focusing on the words used in the statement. As the order relation, a partial order relation and total order relation are conceivable. The “directed graph” represents, by a node, each statement implementation unit contained in requirements from a user who requests a software development, and a partial order relation (or total order relation) a≦b (“≦” is defined as a symbol to mean that b is created from a, similar hereinafter) between start and end points by an arrow. For example, software having such a function programmed therein, or a read-only memory (ROM) having the coded software written therein may be used.

The “topological sort” is a function of executing depth-first search (described later) against the obtained directed graph, and of aligning node columns (sequences of numbers) while obtaining nodes during return through a search path from a reached end. For example, software having such a function programmed therein, or a read-only memory (ROM) having the coded software written therein may be used. This topological sort may be operated to generate a nilpotent matrix by representing the obtained directed graph by an adjacency matrix and executing depth-first search against the directed graph.

Here, the “depth-first search” is an algorithm of:

(1) advancing through interconnected nodes starting from a start-point node to avoid overlapping,

(2) returning to a node having a place to visit when there are no more places to visit (comeback),

(3) advancing again from the node to which the process has returned as in the case of (1), and

(4) finishing the process when there are more places to advance to.

Here, the “search” means various algorithms including, in addition to the aforementioned depth-first search, breadth-first search, iterative deeping, heuristic search, hill climbing, best-first search, Euler circuit, Dijkstra method, and the like. For example, software having such functions programmed therein, or a read-only memory (ROM) having the coded software written therein may be used.

The “Software” used here has a broad meaning. That is, it is a concept including both of a development request from a user and an object program which satisfies the request.

With the foregoing configuration, according to the present invention, since the iteration is prevented, it is possible to develop software of higher efficiency, a higher speed, and higher performance. Moreover, preprocessing for eliminating iteration is automatically executed, and an object program is generated by the Lyee® methodology based on the obtained preprocessed program of a statement execution unit. In other words, it is possible to automate a process from sophistication (alignment) of user requirements to generation of the object program. Thus, the invention provides great effects to the software industry, such as great increases in efficiency of software production, productivity, and quality.

According to a different embodiment of the present invention, each of a program (software) for generating “development target software”, a program generator, a program processor, a tool (including both as a device and as a software), a software development device, a software development support device, and a software development management device can be configured by comprising: means for defining a statement execution unit of any of L2 processing (checking process for input word's attribute), L processing (value generation processing of output word), I2 processing (logical body input processing), and O4 processing (logical body output processing), all of which are necessary for satisfying the requirements, from word-unit statements in which the user requirements to be implemented as a program is declared by a word name, a definition equation, execution conditions of the definition equation, input/output attributes, and attributes of a word value for each logical body accompanied by access conditions and for each word on the logical body; means for defining a (partial) order relation of all the defined L2 processing (checking process for input word's attribute), L processing (value generation processing of output word), I2 processing (logical body input processing), and O4 processing (logical body output processing); means for executing topological sort for the L2 processing, L processing, I2 processing, and O4 processing defined in the (partial) order relation defined in the second step; and means for arranging a predetermined code sequence based on Lyee methodology and relevant to the statement execution unit in accordance with an order of the statement execution units rearranged in the third step.

Furthermore, the present invention is realized by the software produced by the aforementioned “method of generating development target software”, and a recording medium having the software mounted thereon, or a device (hardware) having the software mounted thereon. In this case, the present invention can be constructed as codes in which statement execution units of all necessary for satisfying the requirements, L2 processing (attribute check processing of input word), L processing (value generation processing of output word), I2 processing (logical body input processing), and O4 processing (logical body output processing), all of which are defined by word-unit statement declared based on a word name, a definition equation, execution conditions of the definition equation, input/output attributes, and attributes of a word value, the word-unit statement stating the user requirement to be implemented as a program for each logical body accompanied by access conditions and for each word on the logical body, can be configured as a code sequence based on the Lyee methodology in accordance with an order rearranged by topological sort executed based on a (partial) order relation defined from the requirements declared by the word units.

The present invention is realized as software as a software code proformas used for producing the software by the aforementioned “method of generating development target software”, and a recording medium having the software mounted thereon or a device (hardware) having the software mounted thereon.

Furthermore, the present invention can be realized as an extraction method of information (document (paper, data)) extracted from the requirements by the aforementioned “method of generating development target software), the information (document (paper, data)) extracted by the extraction method, a method of using the extracted information, an information recording medium having such information mounted therein, software having the coded information extraction method/using method, a recording medium/device (hardware) having the software mounted thereon, or information extracted from software development requirements having correlated pieces of information to enable realization of such.

For the logical record, Japanese Patent Application No. 2004-272400 by the same applicant will be referred to, quoted, and made a part of the disclosure.

### ADVANTAGES OF THE INVENTION

According to the present invention, in the program comprising the word unit declaration execution modules, the declaration execution module processing for generating output data can be completed within the minimum number of execution times by avoiding useless iteration, and the program size can be reduced. Specifically, the following points are enabled.

The declaration execution units of word units to be executed can be decided from the declaration of word units declaring the program requirements, and a partial order relation can be defined among the declaration execution units of the word units.

Some of declaration-by-the-word execution units become unnecessary by the optimal ordering, for example, the routing action element, and they are removed. For execution conditions of the routing action element which is information of order to be implemented to maintain requirement meanings, the requirement meanings can be maintained by reflecting the execution conditions in partial order relation definition of the other declaration-by-the-word execution units.

The topological sort is applied to the group of the declaration-by-the-word execution units (not including the routing action element) to rearrange them in an optimal order. Thus, the program can be executed, avoiding unnecessary iteration, in a minimum number of execution times.

### BEST MODES FOR CARRYING OUT THE INVENTION

The present invention is designed to solve the foregoing problems by eliminating the divided units of the conventional Lyee structure program and applying topological sort to the entire program. By the invention, an improvement in execution speed of software developed by the Lyee methodology and an improvement in program size are realized. Hereinafter, referring to the drawings, specific embodiments of the present invention will be described. For a technology of applying the topological sort for the Lyee structure program, the Patent Document 6 by the same applicant will be quoted and made a part of the disclosure.

Chapter 1 gives an outline of divided structures of Lyee software which are integration targets of the present invention. Chapter 2 describes a specific method of integrating basic structures. Chapter 3 describes a example of a program with integrated basic structures by using the present invention and its effects.

<Chapter 1: Mechanism of Divided Structures of Lyee Software>

To integrate the divided structures of the conventional Lyee structure program, first, a mechanism of the divided structures must be understood. Dividing into basic structures is to declare, based on requirements, how words should be grouped to output and with what conditions they should be output. Declaration elements of word units include input/output attributes. In addition to its input/output classification, requirements to be declared are input or output groups (logical record) to which each word belongs and conditions under which the input/output groups are input or output. For details on how requirement information regarding this input/output is accurately taken out from a requirement definition indicating various processing operations, Japanese Patent Application No. 2004-272400 by the same applicant will be quoted, and made a part of the disclosure. Here, regarding a meaning of the division into the basic structures, an outline only considered necessary for explanation of the present invention will be given.

1. Meaning of Division into Basic Structures

Meaning of Divided Structures

The divided structures of the Lyee software are made by grouping declaration execution modules which are modules of minimum units in accordance with a certain rule. The structures are shown in FIG. 1.

1) Synchronization Range

Modules constituting a program are first grouped into a unit indicated by “synchronization range” in (a) of FIG. 1. The synchronization range is a range of processes which are defined in requirement to be executed by a computer by an event that is a user instruction to the program of executing processes (e.g., command of pressing a button, selecting a menu, or the like). In other words, the synchronization range is a group of modules to be executed by the same event as an execution condition. According to the Lyee methodology, completion of processes in the synchronization range is called “synchronization”. The completion of the processes in the synchronization range means that generation and outputting of output words defined by the requirements to be executed by the event are all completed.

2) Basic Structure

Next, as indicated by 101 in (a) of FIG. 1, modules within the synchronization range are grouped into basic structures. Input/output processing of the computer is executed not by the data but by the set of data. A set of words simultaneously input to/output from the same definition body is called a logical record according to the Lyee methodology. The logical record is a unit to hold a value of a word such as a screen, a file, a form, or a transmission. It is a basic structure that groups modules regarding the same output logical record. A role of the program is to generate and output a value of an output word specified by user's event. However, the number of outputs made within the synchronization range by one event is not limited to one. In many cases, two or more output logical record are output within one synchronization range, e.g., saving (outputting) of a generation result of word values in a file in addition to displaying (outputting) of them on a screen, and synchronization ranges are grouped into a plurality of basic groups.

3) Palette

Lastly, modules in the basic structure are grouped into three kinds. A group of modules in the basic structure is called a palette according to the Lyee methodology. Three palettes are called a W02 palette, a W03 palette, and a W04 palette. The W02 palette is a set of modules regarding inputting of input words. The W03 palette is a set of modules regarding determination of calculation conditions of definition equations of output words. The W04 is a set of modules regarding generation of values by execution of the definition equations of the output words, and outputting of the values.

Next, an execution order of the basic structures will be described.

1) Within Same Synchronization Range

There is a start-point and end-point relation among the basic structures. Thus, a basic structure to be executed next is decided by depth-first search. An execution order is decided by applying topological sort to the declaration execution modules within the same synchronization range.

2) Execution Order of Synchronization Ranges

Which synchronization range should be executed depends on an event given by the user. For example, there are buttons for executing processing A and processing B. The user presses one of these buttons to decide processes (i.e., synchronization range) to be executed by the program. Thus, as the entire program comprises a plurality of synchronization ranges having different events set as execution conditions, topological sort cannot simply be applied to the declaration execution modules of the entire program. In the Chapter 2, by using specifications having two synchronization ranges of two events, a method of integrally applying topological sort to declaration execution modules within different synchronization ranges will be described.

2. Target of Topological Sort

A target of optimal ordering by the topological sort is processes executed by declaration execution modules which are components of the Lyee software. There are two kinds of declaration execution modules. One is called a logical element that is a module to establish a word value. The other is called an action element that is a module to execute processes such as input/output other than that of value establishment.

The Patent Document 6 by the same applicant discloses an embodiment of topological sort in which a logical element for establishing a value is treated as an element of a directed graph and an adjacency matrix and represented by a mathematical model. As in the case of the logical element, an action element can be treated as an element of a directed graph and an adjacency matrix, and can be a target of topological sort. A large difference between the logical element and the action element is only that the logical element act (action to generate a value) on only one word while the action element simultaneously act on two or more words. For example, a routing action element (specifying a basic structure to be executed next) act on a set of words called basic structures, and an output act element (outputting output words) act on a set of words called output logical record.

Hereinafter, discussing on declaration execution modules one by one, a method of getting them a target of topological sort will be described.

[Logical Element]

[L2]

L2 is a declaration execution module for checking attributes of input words with requirements. Under any conditions, conditions for enabling execution of the L2 processing are that a value of the input word has been fetched (input) from a medium into a memory area. Thus, the L2 process the topological sort be applied to is considered that its start point is I2 inputting a value of the L2.

An event command (button or menu) is also treated as one of the input words.

[L3 and L4]

In the current Lyee software structure, generation process of an output word is realized by two modules of L3 (execution of calculation condition equation) and L4 (execution of definition equation). Further, when an output word a has plural definition equations (word in this case is called an equivalent word), L3 and L4 are provided by numbers equal to the numbers of sets of definition equations and calculation equations.

It is assumed that the output word a has plural definition equations (word in this case is called an equivalent word) and declared as follows.

| <Definition equation> | <Calculation condition> |
|---|---|
| (1) b + c | e > 10 |
| (2) b − d | e ≦ 10 |

While the equivalent word has plural definition equations, one value must always be given to the output word. Thus, the calculation conditions for the definition equation of the equivalent word must be exclusive and complete.

Under any conditions, conditions for executing the generation process of the word a is that all start-point words used in all the definition equations and calculation condition equations of the word a have been decided. In other words, as for this target of topological sort, definition equations of words b, c, d and e only need to be executed first.

Accordingly, targets of topological sort are all sets of L3 and L4 processes for each output word, and their start points are L2 processes of an input word and a set of L4 and L3 processes of an output word, which are used as start points in the definition equations and the calculation conditions.

[Action Element]

[Input Action Element I2]

I2 is a module to execute process of fetching (inputting) a value from a medium into a memory. Thus, under any conditions, conditions for execution of the I2 process are unconditional (i.e., nondependent on other processes). The I2 process as a target of topological sort does not have any start point (however, in the case of an input from a file, a value of a key word must be established, which is a key for accessing the file).

[Output Action Element O4]

O4 is a module for executing process of writing (outputting) values of words from a Lyee software area into an output buffer of the memory. Accordingly, under any conditions, conditions to execute the O4 process are that values of output words to be output has been established (i.e., one L4 has been executed). The O4 process as a target of topological sort can be regarded that its start points are output words to be output.

[Structure Action Element S4]

S4 is a module to execute process of initializing (recording initial values) an area of recording a word value and an area of recording a process result (e.g., output has been normally completed, or not completed). In the conventional Lyee having the iteration structure, prohibition of overwriting and initialization in the word value area are means for the mechanism of the iteration structure. Thus, in the Lyee structure optimally ordered by applying the topological sort to the entire program, the initialization of the word value areas becomes unnecessary.

On the other hand, the initialization of the recording area of the processing result is also necessary for the integrated Lyee structure because it is not for the mechanism of the iteration structure.

[Routing Action Element]

A routing action element is a module to execute process of specifying a palette to be executed next. The routing action element plays a role of linking palettes which are divided units of the program, and basic structures which constitute a set of palettes.

<Routing Action Element for Transition Between Palettes within a Basic Structure>

<Routing Action Element for Transition Between Basic Structures>

Hereinafter, a meaning of a routing action element for selecting a basic structure to be executed from one to another will be described by taking an example.

### EXAMPLE 1

FIG. 2 shows a screen of a system, where a user obtains a value of a data item g by inputting data to data items c and d and pressing an execution button a or b. A reference numeral 701 denotes an input data field of the data item c, a reference numeral 702 denotes an input data field of the data item d, a reference numeral 703 denotes an output data field of the data item g, a reference numeral 704 denotes the execution button a, and a reference numeral 705 denotes the execution button b. When the execution button a is pressed, a value of g is calculated by a definition equation c+d. When the execution button b is pressed, a value of g is calculated by a definition equation c×d. As they are never pressed simultaneously, the execution buttons a and b are conditions for executing one of the two definition equations to generate the value of g.

A program of the screen of FIG. 2 is as shown in FIG. 3 when it is represented by divided units of basic structures. BS1, BS2, and BS3 of FIG. 3 are all basic structures. The basic structure BS1 is a basic structure of an output logical record to the screen shown in FIG. 2. The BS1 includes input words a and b which are execution buttons, input words b and c which are input data items, an output word g which is an output data item, and a routing action element Xᵣ.

The basic structure BS2 is a basic structure (medium is a file) for calculating a value of the output data item g by the equation c+d when the equation button a is pressed. It includes a word e to record a result of the equation c+d. The basic structure BS3 is a basic structure (medium is a file) for calculating a value of the output data item g when the execution button b is pressed. It includes a word f to record a calculation result of the equation c×d.

The routing action element Xᵣ selects execution of one of the basic structures BS2 and BS3 for calculating the value of the output word g after the user inputs data to the screen (BS1 is executed). Words belonging to the two basic structures are established depending on which of the buttons a and b are pressed. Accordingly, the routing action element Xᵣ selects the BS 2 as a basic structure to be executed next when the execution button a is pressed (word a=true, there is a value), and the BS3 as a basic structure to be executed next when the execution button b is pressed (word b=true, there is a value). Execution moves to a next basic structure after input data have been prepared. Thus, it is also a execution condition of the routing action element Xᵣ that values are in the words c and d.

By executing the basic structure BS2 or BS3, a value of the output word g is established in the word e or f. The output word g of the basic structure BS1 for outputting the output data to the screen is defined as g=e when a value is established in the word e (e=true), and as g=f when a value is established in the word f (f=true).

The aforementioned definitions of the words are shown in Table 1.

TABLE 1

| | Input/output | Definition | Definition equation execution |
|---|---|---|---|
| Word | attribute | equation | conditions |
| a | Input | — | — |
| b | Input | — | — |
| c | Input | — | — |
| d | Input | — | — |
| xᵣ | (Routing | BS2 is | (1) a = true (button a is pressed, |
| | action | selected | and a has a value), c = true, |
| | element) | | and d = true |
| | | BS3 is | (2) b = true (button b is pressed, |
| | | selected | and b has a value), c = true, |
| | | | and d = true |
| e | Output | c + d | Xᵣ selects BS2 |
| f | Output | d × d | Xᵣ selects BS3 |
| g | Output | e | e = true (e has a value) |
| | | f | f = true (f has a value) |

[Control Module]

In the conventional Lyee structure, there are divided structures, and iterations occur in each divided units. Thus, two kinds of control modules, i.e., a palette function (provided by a number equal to that of palettes) of calling and executing each module in the palette and a palette chain function (one in each program) of calling and executing such a palette function itself, have been necessary.

After the topological sort, all the programs are integrated and ordered. Thus, only one control module for calling the modules in the programs is necessary for all the programs.

<Chapter 2: Integration of Basic Structures and Topological Sort>

A specific procedure of the topological sort will be described by using requirements of the Example 1.

1. Adjacency Matrix of Basic Structures

FIG. 4 is a directed graph showing the word relation of FIG. 3. The words a to d which are input words belonging to the basic structure BS1 become endmost start points of a word network represented by the directed graph. Similarly, as shown in the Table 1, it is necessary for the word Xᵣ, which is a routing action element belonging to the basic structure BS1, to have a value (to get result of Boolean operation to decide a next basic structure to be executed) that values of the word a or b and the words c and d. Therefore, the word Xᵣ is linked with the four words by arrows starting separately from the four words. As for the word e belonging to the basic structure BS2 and the word f belonging to the basic structure BS3, since the words c, d and Xᵣ are necessary to establish values of them, they are linked with these three words by arrows starting separately from the three words. As for the output word g belonging to the basic structure BS1, since the word e and the word f are necessary to establish its value, it is linked with these two words by arrows starting separately from the two words.

Next, the system of the Example 1 shown by the directed graph of FIG. 4 will be described by using an adjacency matrix. First, an adjacency matrix F1 indicating the basic structure BS1 (901) of the input word is represented by the following equation 1.
Adjacency Matrix of Basic Structure BS1 (Input Words)

$$F 1 = \begin{matrix}\begin{matrix}a & b & c & d & {x}_{r}\end{matrix} \\ \begin{matrix}a \\ b \\ c \\ d \\ {x}_{r}\end{matrix} [ \begin{matrix}0 & 0 & 0 & 0 & 0 \\ 0 & 0 & 0 & 0 & 0 \\ 0 & 0 & 0 & 0 & 0 \\ 0 & 0 & 0 & 0 & 0 \\ 1 & 1 & 1 & 1 & 0\end{matrix} ]\end{matrix} \qquad [ Equation 1 ]$$

As elements of the BS1 (input words) are the words a to d and xᵣ, the matrix F1 comprises these elements. The words a to d that are input words have no start-point words. Accordingly, rows of end-point words a to d (intersection points with columns of start-point words a to d and xᵣ) become “0” indicating nonuse as start-point words. The word xᵣ that is a routing action element has the words a to d as the start points as shown in the directed graph of FIG. 4. Accordingly, in a row of the end-point word xᵣ, intersection points with these words become “1” indicating that they are start-points.

Next, an adjacency matrix F2 indicating a combination of the basic structures BS2 and BS3 (hereinafter, basic structures BS2 & BS3) is represented by the following equation 2.
Adjacency Matrix of Basic Structures BS2 & BS3

$$F 2 = \begin{matrix}e & f \\ \begin{matrix}e \\ f\end{matrix} & [ \begin{matrix}0 & 0 \\ 0 & 0\end{matrix} ]\end{matrix} \qquad [ Equation 2 ]$$

As elements of the BS2 & BS3 are only words e and f, the matrix F2 comprises these two elements. The words e and f are independent of each other (i.e., neither of the words uses another as a start-point word), and thus all of intersection points thereof become “0”.

An adjacency matrix F3 of a set of output words of the basic structure BS1 is represented by the following equation 3 Adjacency matrix of basic structure BS1 (output word)

$$F 3 = g \begin{matrix}g \\ [ 0 ]\end{matrix} \qquad [ Equation 3 ]$$

An element of the BS3 is only a word g. Accordingly, the matrix F3 comprises only one word g1. Since the word g is not used as a start point itself, an intersection point becomes “0”.

Based on the basic structure units constituting the system of the Example 1, the relations among the elements in the same basic structure have been represented by the adjacency matrixes.

2. Integration of Basic Structures by Connection Adjacency Matrix

Next, to integrate the above into one adjacency matrix as the structures of the entire system, description will be made for a connection adjacency matrix that links the basic structures by showing a relation between words in the different basic structures.

A relation between a word of a basic structure and a word of other basic structure is represented by a relation of end-point and start-point words as shown in FIG. 4. It can be said that the basic structures are linked together by a relation words belonging to the structures. The followings are obvious from FIG. 4.

1) When considering words of the basic structure BS1 (input) as end-point words, words of all the other basic structures appear after the word of the BS1 (input). Thus, these latter words cannot be start-point words of the former.

2) When considering words of the basic structures BS1 and BS2 as end-point words, the word of the BS1 (input) that appears before the words of the BS2 & BS3 can be start-point words, while an word of the BS1 (output) cannot be a start-point word.

3) When considering the word of the basic structure BS1 (output) as an end-point word, words of the BS2 & BS3 and the BS1 (input) can be start-point words as they appear before the word of the BS1 (output).

As a result of the foregoing consideration, it is understood important for the connection adjacency matrix linking the basic structures together that it should indicate a relation between a basic structure and other basic structure including words that can be start-point words of the words belonging to the former basic structure. It is because as shown in the directed graph, relations between words are all directed from start-point words to end-point words. Thus, relations between basic structures are all directed from a basic structure including start-point words to a basic structure including end-point words, while there is no reverse relation (in the connection adjacency matrix indicting such a relation among basic structures, intersection points all become 0).

Hereinafter, the connection adjacency matrixes that link the basic structures (indicating the relation from the basic structure including the start-point word to the basic structure including the end-point word) of the Example 1 will be considered one by one.

An equation 4 represents a connection adjacency matrix FC1 which indicates a relation from the basic structure BS1 (input) (including start-point word) to the basic structures BS2 and BS3 (including end-point words).

$$FC 1 = \begin{matrix}\begin{matrix}a & b & c & d & {x}_{r}\end{matrix} \\ \begin{matrix}e \\ f\end{matrix} [ \begin{matrix}0 & 0 & 1 & 1 & 1 \\ 0 & 0 & 1 & 1 & 1\end{matrix} ]\end{matrix} \qquad [ Equation 4 ]$$

The adjacency matrix FC1 indicates that, when the words e and f as elements of the basic structures BS2 & BS3 are end-point words, the words a to d and xᵣ as elements of the BS1 (input) are start-point words for them, showing a relation between the two basic structures. As shown in FIG. 4, the words e and f use the words c, d and xᵣ as start-point words. Thus, in the FC1, intersection points of the rows of the end-point words e and f with the start-point words c, d and xᵣ become “1”, and intersection points with the other start-point words become “0”.

An equation 5 represents an adjacency matrix FC2 which shows a relation from the basic structure BS1 (input) and the basic structures BS2 & BS3 (start-point words) to the basic structure BS 1 (output) (end-point word)

$$FC 2 = \begin{matrix}\begin{matrix}a & b & c & d & e & f\end{matrix} \\ g [ \begin{matrix}0 & 0 & 0 & 0 & 1 & 1\end{matrix} ]\end{matrix} \qquad [ Equation 5 ]$$

The adjacency matrix FC2 indicates that, when the word g as an element of the basic structure BS1 (output) is an end-point word, the words a to d, xᵣ, e, and f as elements of the BS1 (input), BS2, and BS3 which appear before them in the directed graph are start-point words, showing a relation between the two groups. As shown in FIG. 4, the word g uses the words e and f as start-point words. Thus, in the FC2, intersection points of the row of the end-point word g with the start-point words e and f become “1”, and intersection points with the other start-point words become “0”.

The connection adjacency matrixes having meanings of linkage among the basic structures constituting the system of the Example 1 have been described. To simplify explanation of a process of integrating the matrixes into one adjacency matrix for the entire system, connection adjacency matrixes among the basic structures which have no relations will be described below. An equation 6 represents a connection adjacency matrix FC3 showing that there is no relation from the basic structures BS2 & BS3 (start-point words) to an the basic structure BS 1 (input) (end-point word).

$$FC 3 = \begin{matrix}\begin{matrix}e & f\end{matrix} \\ \begin{matrix}a \\ b \\ c \\ d \\ {x}_{r}\end{matrix} [ \begin{matrix}0 & 0 \\ 0 & 0 \\ 0 & 0 \\ 0 & 0 \\ 0 & 0\end{matrix} ]\end{matrix} \qquad [ Equation 6 ]$$

An equation 7 represents a connection adjacency matrix FC4 indicating that there is no relation from the basic structure BS1 (output) (start-point word) to the basic structure BS1 (input) (end-point word).

$$FC 4 = \begin{matrix}g \\ \begin{matrix}a \\ b \\ c \\ d \\ {x}_{r}\end{matrix} [ \begin{matrix}0 \\ 0 \\ 0 \\ 0 \\ 0\end{matrix} ]\end{matrix} \qquad [ Equation 7 ]$$

An equation 8 represents a connection adjacency matrix FC5 indicating that there is no relation from the basic structure BS1 an (output) (start-point word) to the basic structures BS2 & BS3 (end-point words).

$$FC 5 = \begin{matrix}g \\ \begin{matrix}e \\ f\end{matrix} [ \begin{matrix}0 \\ 0\end{matrix} ]\end{matrix} \qquad [ Equation 8 ]$$

An equation 9 represents the system of the Example 1 as one adjacency matrix F by using the adjacency matrixes F1 to F3 and the connection adjacency matrixes FC1 to FC5 described above.

$$F = [ \begin{matrix}F 1 & 0 & 0 \\ FC 1 & F 2 & 0 \\ FC 2 & & F 3\end{matrix} ] = \begin{matrix}a \\ b \\ c \\ d \\ {x}_{r} \\ e \\ f \\ g\end{matrix} \begin{matrix}\begin{matrix}a & b & c & d & {x}_{r} & e & f & g\end{matrix} \\ [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 1 & 1 & 1 & 1 & 0 & 0 & 0 & 0 \\ 0 & 0 & 1 & 1 & 1 & 0 & 0 & 0 \\ 0 & 0 & 1 & 1 & 1 & 0 & 0 & 0 \\ 0 & 0 & 0 & 0 & 0 & 1 & 1 & 0\end{matrix} ]\end{matrix} \qquad [ Equation 9 ]$$

In the above equation, a matrix constituted of F1, F2, F3 and FC1, FC2, and 0 (means an adjacency matrix whose intersection points are all 0 on a right side of “F=”, which correspond to FC3, FC4, and FC5) indicates how an adjacency matrix and a connection adjacency matrix of basic structure units are integrated to represent the entire system. Next, changing these elements into words, an adjacency matrix having a, b, c, d, x, e, f, and g set as elements of the matrix are shown on the right side. FIG. 5 more easily shows how F1, F2, F3, FC1, FC2, FC3, FC4, and FC5 are integrated to constitute F. In FIG. 5, a portion 1001 is F1, a portion 1002 is F2, a portion 1003 is F3, a portion 1004 is FC1, and a portion 1005 is FC2. In a connection adjacency matrix whose intersection points are all 0, FC3 is a portion 1006, FC4 is a portion 1007, and FC5 is a portion 1008.

Thus, one system that comprises two or more basic structures can be represented by one adjacency matrix.

As the entire system can be represented by one adjacency matrix as described above, topological sort disclosed in the Patent Document 6 by the same applicant is applied to the adjacency matrix of the system to rearrange the programs of the unit words in an optimal order so that value states of all the words can be established by a minimum number of execution times (i.e., generation of all output words is completed).

In the adjacency matrix F of the system of the Example 1, as shown in FIG. 6, intersection points with start-point words having values of 1 are all within a left lower triangle (1301). As described above in the Chapter 1, it means that the words are arranged in an optimal order. Thus, it can be said that the adjacency matrix F of the equation 9 has been subjected to topological sort, and a word order has been set to enable completion of generation of output words by a minimum number of execution times if an initial value is provided to a state vector of a word.

Now, effects of executing the topological sort will be complemented. According to the program of word units arranged in an optimal execution order by the topological sort, one-round processing can generate values of all output words. However, in the case of the entire system, to be more accurate, realization by a “minimum number of execution times” is a proper expression. It is because in the entire system, a process of repeatedly using the same calculation equation may be included, where a temporary recording area are provide as in the case of totaling processing. Needless to say, “repetition” in this case is not useless iteration. A number obtained by subtracting 1 from the total number of data becomes the minimum number of iteration times. Using a connection adjacency matrix, such a totaling process can be represented by one adjacency matrix.

As one example of the search technique, the topological sort has been described. However, other search techniques may be used. The adjacency matrix definition has been included to facilitate understanding of the invention. However, it is not an essential step. In other words, search such as topological sort may be reached directly from definition of an inter-declaration relation or via creation of a directed graph without defining an adjacency matrix. This is also within the teachings of the present invention, and capable of achieving the object of the invention.

3. Verification of Adjacency Matrix of Program

In this section, as the adjacency matrix F of the system described in the above section functions as a function of generating values of the output words, and has been subjected to the topological sort, the completion of the generation of all the output words by the minimum number of execution times will be verified by a calculation operation of multiplication with word state vectors disclosed in the Patent Document 6 by the same applicant. It can be said that the adjacency matrix F functions as a function after the value of the output word g is decided. Additionally, a system of Example 5 does not include iteration processing similar to the aforementioned totaling processing. It can therefore be said that processing is completed by a minimum number of execution times if a state of a value of an output word g is established by one-round processing.

In the system of the Example 1, states of value of words before the user executes inputting, i.e., an initial value of a state vector X of words is represented by the following equation 10 while all the elements are “null (undecided)” as disclosed in the Patent Document 6 by the same applicant.

$$X = \begin{matrix}a \\ b \\ c \\ d \\ {x}_{r} \\ e \\ f \\ g\end{matrix} [ \begin{matrix}null \\ null \\ null \\ null \\ null \\ null \\ null \\ null\end{matrix} ] \qquad [ Equation 10 ]$$

Calculation processing of multiplying the adjacency matrix F (i.e., system of the Example 1) of the equation 9 by the state vector X of the equation 10 is executed (i.e., an input is made to the system of the Example 1). A state of a value of a word changed by FX calculation processing will be described for each of end-point words.

(1) Calculation of the End-Point Word a During One-Round Processing

Calculation of the end-point word a during one-round processing is as follows.

$$\begin{matrix}a = 0 \cdot null + 0 \cdot null + 0 \cdot null + 0 \cdot null + 0 \cdot null + 0 \cdot null + \\ 0 \cdot null + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of a value of the input word a is established even if it is multiplied by a state of any value, and changed from null to (+1). In other words, a value is established by an input. As a result, a state of a value of each word after completion of the word a line during one-round processing is as shown in Table 2 below.

TABLE 2

| | a | b | c | d | xᵣ | e | f | g |
|---|---|---|---|---|---|---|---|---|
| State of value | +1 | null | null | null | null | null | null | null |

(2) Calculation of the End-Point Word B During One-Round Processing

Calculation of the end-point word b during one-round processing is as follows because the state of value of the words of the Table 2 is used.

$$\begin{matrix}b = 0 \cdot ( + 1 ) + 0 \cdot null + 0 \cdot null + 0 \cdot null + 0 \cdot null + 0 \cdot null + \\ 0 \cdot null + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of value of the input word b is established even if it is multiplied by a state of any value, and changed from null to (+1). As a result, a state of a value of each word after completion of the word b line during one-round processing is as shown in Table 3 below.

TABLE 3

| | a | b | c | d | xᵣ | e | f | g |
|---|---|---|---|---|---|---|---|---|
| State of value | +1 | +1 | null | null | null | null | null | null |

In the system of the Example 1, the words a and b are buttons chosen alternatively on the screen. Accordingly, states of value of both words are established by selecting one of the buttons.

(3) Calculation of the End-Point Word C During One-Round Processing

Calculation of the end-point word c during one-round processing is as follows because the state of value of the words of the Table 3 is used.

$$\begin{matrix}c = 0 \cdot ( + 1 ) + 0 \cdot ( + 1 ) + 0 \cdot null + 0 \cdot null + 0 \cdot null + 0 \cdot null + \\ 0 \cdot null + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of value of the input word c is established even if it is multiplied by a state of any value, and changed from null to (+1). As a result, a state of value of each word after completion of the word c line during one-round processing is as shown in Table 4 below.

TABLE 4

| | a | b | c | d | xᵣ | e | f | g |
|---|---|---|---|---|---|---|---|---|
| State of value | +1 | +1 | +1 | null | null | null | null | null |

(4) Calculation of the End-Point Word d During One-Round Processing

Calculation of the end-point word d during one-round processing is as follows because the state of value of the words of the Table 4 is used.

$$\begin{matrix}d = 0 \cdot ( + 1 ) + 0 \cdot ( + 1 ) + 0 \cdot ( + 1 ) + 0 \cdot null + 0 \cdot null + 0 \cdot null + \\ 0 \cdot null + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of a value of the input word d is established even if it is multiplied by a state of any value, and changed from null to (+1). As a result, a state of value of each word after completion of the word d line during one-round processing is as shown in Table 5 below.

TABLE 5

| | a | b | c | d | xᵣ | e | f | g |
|---|---|---|---|---|---|---|---|---|
| State of value | +1 | +1 | +1 | +1 | null | null | null | null |

(5) Calculation of the End-Point Word xᵣ During One-Round Processing

Calculation of an end-point word xᵣ during one-round processing is as follows because the state of value of the words of the Table 5 is used.

$$\begin{matrix}{x}_{r} = 1 \cdot ( + 1 ) + 1 \cdot ( + 1 ) + 1 \cdot ( + 1 ) + 1 \cdot ( + 1 ) + 0 \cdot null + 0 \cdot null + \\ 0 \cdot null + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As the states of value of the words a to d which become start-point words of the word xᵣ have been established, i.e., definition equation execution conditions (1) and (2) of the word xᵣ which is a routing action element shown in the Table 1 have been satisfied, a state of a value of the word xᵣ is changed from null to established (+1). As a result, a state of value of each word after completion of the word xᵣ line during one-round processing is as shown in Table 6 below.

TABLE 6

| | a | b | c | d | xᵣ | E | f | g |
|---|---|---|---|---|---|---|---|---|
| State of value | +1 | +1 | +1 | +1 | +1 | null | null | null |

(6) Calculation of the End-Point Word e During One-Round Processing

Calculation of the end-point word e during one-round processing is as follows because the state of value of the words of the Table 6 is used.

$$\begin{matrix}e = 0 \cdot ( + 1 ) + 0 \cdot ( + 1 ) + 1 \cdot ( + 1 ) + 1 \cdot ( + 1 ) + 1 \cdot ( + 1 ) + 0 \cdot null + \\ 0 \cdot null + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As the states of values of the words c, d and xᵣ which become start-point words of the word e have been established, i.e., values of the start-point words of a definition equation c+d, and the routing action element xᵣ has specified a basic structure to be executed, a state of value of the word e is changed from null to established (+1). As a result, a state of value of each word after completion of the word e line during one-round processing is as shown in Table 7 below.

TABLE 7

| | a | b | c | d | xᵣ | e | f | g |
|---|---|---|---|---|---|---|---|---|
| State of value | +1 | +1 | +1 | +1 | +1 | +1 | null | null |

(7) Calculation of the End-Point Word f During One-Round Processing

Calculation of the end-point word f during one-round processing is as follows because the state of value of the words of the Table 7 is used.

$$\begin{matrix}f = 0 \cdot ( + 1 ) + 0 \cdot ( + 1 ) + 1 \cdot ( + 1 ) + 1 \cdot ( + 1 ) + 1 \cdot ( + 1 ) + 0 \cdot ( + 1 ) + \\ 0 \cdot null + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As the states of value of the words c, d and xᵣ which become the start-point words of the word f have been established, a state of value of the word f is changed from null to (+1). As a result, a state of value of each word after completion of the word f line during one-round processing is as shown in Table 8 below.

TABLE 8

| | a | b | c | d | xᵣ | E | f | g |
|---|---|---|---|---|---|---|---|---|
| State of value | +1 | +1 | +1 | +1 | +1 | +1 | +1 | null |

In the system of the Example 1, execution conditions of the words e and f are alternative conditions. Thus, when one of the conditions is established to be true, the other condition is established to be false, thereby establishing values of both. For example, when the BS2 is selected, “definition equation execution condition of the word e=true” is decided, and a value is provided to the word e, thereby establishing a state of value. On the other hand, in the case of the word f, “definition equation execution condition=false” is decided, and a value is not provided to the word f, thereby establishing a state of value. Thus, when the routing action element selects one of the basic structures, states of value of the words e and f have been established.

(8) Calculation of the End-Point Word g During One-Round Processing

Calculation of the end-point word g during one-round processing is as follows because the state of value of the word of the Table 8 is used.

$$\begin{matrix}g = 0 \cdot ( + 1 ) + 0 \cdot ( + 1 ) + 0 \cdot ( + 1 ) + 0 \cdot ( + 1 ) + 0 \cdot ( + 1 ) + 1 \cdot ( + 1 ) + \\ 1 \cdot ( + 1 ) + 0 \cdot null \\ = ( + 1 ) + ( + 1 ) + ( + 1 ) + ( + 1 ) + ( + 1 ) + ( + 1 ) + ( + 1 ) + ( + 1 ) \\ = ( + 1 )\end{matrix}$$

As the states of value of the words e and f which become the start-point words of the word g have been established, a state of value of the word g is changed from null to (+1). As a result, a state of value of each word after completion of the word g line during one-round processing is as shown in Table 9 below.

TABLE 9

| | a | b | c | d | xᵣ | E | f | g |
|---|---|---|---|---|---|---|---|---|
| State of value | +1 | +1 | +1 | +1 | +1 | +1 | +1 | +1 |

Thus, one round of calculation processing of all the word lines of the adjacency matrix F has been finished. Accordingly, the Table 9 shows a result of the FX. A state vector X₁ of the following equation 11 is a result of the FX.

$${X}_{1} = \begin{matrix}a \\ b \\ c \\ d \\ {x}_{r} \\ e \\ f \\ g\end{matrix} [ \begin{matrix}+ 1 \\ + 1 \\ + 1 \\ + 1 \\ + 1 \\ + 1 \\ + 1 \\ + 1\end{matrix} ] \qquad [ Equation 11 ]$$

As descried above, in the adjacency matrix F, the word unit programs are arranged in an optimal order by the topological sort to be applied. Thus, states of value of all the words are decided by one-round calculation processing, thereby deciding a value of the output word g.

4. Removal of Routing Action Element

Execution conditions of the routing action element are equal to those for executing the definition equation of a set (one or more) of all words belonging to a basic structure specified by the routing action element. It is because all words of the basic structure are executed when the conditions of the routing action element are satisfied. Accordingly, the execution conditions of the route operation element can be changed to those of the words belonging to the basic structure specified by the routing action element.

Specific description in the case of the system of the Example 1 is as follows. First, the definition equation and the definition equation execution conditions of the words xᵣ that is routing action element, e and f are shown in Table 10 below.

TABLE 10

| Word | Definition equation | Definition equation execution conditions |
|---|---|---|
| xᵣ | BS2 is selected | (1) a = true (button a is pressed, and a |
| | | has a value), c = true and d = true |
| | BS3 is selected | (2) b = true (button b is pressed, and b |
| | | has a value), c = true and d = true |
| e | c + d | Xᵣ selects BS2 |
| f | d × d | Xᵣ selects BS3 |

Thus, the Xᵣ condition (1) “a=true, c=true and d=true” is replaced by the execution condition “Xr selects BS2” of the word e belonging to the basic structure BS2 selected when this condition (1) is established. The condition (2) “b=true, c=trued and d=true” is replaced by the execution condition “Xr selects BS3” of the word f belonging to the basic structure BS3 selected when this condition (2) is established. As a result, the definition equation and the definition equation execution conditions become as shown in Table 11 below.

TABLE 11

| Word | Definition equation | Definition equation execution conditions |
|---|---|---|
| e | c + d | a = true (button a is pressed, and a has |
| | | a value), c = true and d = true |
| f | c × d | b = true (button b is pressed, and b has |
| | | a value), c = true and d = true |

As shown in Table 11, when the execution conditions of the routing action elements are replaced by the execution conditions of the words of the selected basic structure, linkage among the BS1, BS2 and BS3 is established by the execution conditions of the words of the BS2 and the BS3. Thus, the routing action elements only indicate that conditions for executing a next basic structure have been satisfied (input words c and d have values, and button a or b has been pressed). This means that no change occurs in the meaning of the system even if the routing action elements are removed. Accordingly, after replacing the execution conditions of the routing action elements by the execution conditions of the words of the basic structure selected, the routing action elements can be removed from the adjacency matrix of the entire system.

FIG. 7 is a directed graph showing a relation among the words of the system of the Example 1 after removal of the routing action elements. In FIG. 7, the word xᵣ that is a routing action element is removed, and a relation between the words e and f and start-point words is shown in accordance with the definition equation and the definition equation execution conditions defined in the Table 11. That is, the word e has the word a (definition equation execution condition “execution button a is pressed”), and the words c and d (definition equation “c+d” and definition equation execution condition “c=true and d=true”) as start-point words. The word f has the word b (definition equation execution condition “execution button b is pressed”) and words c and d (definition equation “c+d” and definition equation execution condition “c=true and d=true”) as start-point words. A relation from the words e and f to the word g is similar to that shown in FIG. 4.

The system of the Example 1 after removal of the routing operation elements is represented as follows by adjacency matrixes in accordance with the directed graph of FIG. 7. F1′ of an equation 12 is an adjacency matrix of the basic structure BS1 (input). The word xᵣ that is a routing action element is removed from the elements.

$$F {1}^{′} = \begin{matrix}\begin{matrix}a & b & c & d\end{matrix} \\ \begin{matrix}a \\ b \\ c \\ d\end{matrix} [ \begin{matrix}0 & 0 & 0 & 0 \\ 0 & 0 & 0 & 0 \\ 0 & 0 & 0 & 0 \\ 0 & 0 & 0 & 0\end{matrix} ]\end{matrix} \qquad [ Equation 12 ]$$

F2′ of an equation 13 is an adjacency matrix of the basic structures BS2 & BS3.

$$F {2}^{′} = \begin{matrix}\begin{matrix}e & f\end{matrix} \\ \begin{matrix}e \\ f\end{matrix} [ \begin{matrix}0 & 0 \\ 0 & 0\end{matrix} ]\end{matrix} \qquad [ Equation 13 ]$$

F3′ of an equation 14 is an adjacency matrix of the basic structure BS1 (output).

$$F {3}^{′} = \begin{matrix}g \\ g [ 0 ]\end{matrix} \qquad [ Equation 14 ]$$

FC1 of an equation 15 is a connection adjacency matrix indicating a relation from the basic structure BS1 (input) to the basic structures BS2 & BS3. As the routing action element has been removed, the word Xᵣ as an element of a start-point word is removed. The words e and f respectively have new words a and b as start-point words because of changing of the execution conditions of the routing action element as shown in the Table 11. Thus, for the end-point word e, the number of intersection points with the start-point word a is 1 in addition to those with the start-point words c and d. For the end-point word f, the number of intersection points with the word b is 1 in addition to those with the start-point words c and d.

$$FC {1}^{′} = \begin{matrix}\begin{matrix}a & b & c & d\end{matrix} \\ \begin{matrix}e \\ f\end{matrix} [ \begin{matrix}1 & 0 & 1 & 1 \\ 0 & 1 & 1 & 1\end{matrix} ]\end{matrix} \qquad [ Equation 15 ]$$

FC2′ of an equation 16 is a connection adjacency matrix indicating a relation from the basic structures BS2 & BS3 to the basic structure BS1 (output). As the routing action element has been removed, the word Xᵣ as an element of a start-point word is removed.

$$FC {2}^{′} = \begin{matrix}\begin{matrix}a & b & c & d & e & f\end{matrix} \\ g [ \begin{matrix}0 & 0 & 0 & 0 & 1 & 1\end{matrix} ]\end{matrix} \qquad [ Equation 16 ]$$

FC3′ of an equation 17 is a connection adjacency matrix indicating that there is no relation from the basic structures BS2 & BS3 to the basic structure BS1 (input). As the routing action element has been removed, the word Xᵣ as an element of a start-point word is removed.

$$FC {3}^{′} = \begin{matrix}\begin{matrix}e & f\end{matrix} \\ \begin{matrix}a \\ b \\ c \\ d\end{matrix} [ \begin{matrix}0 & 0 \\ 0 & 0 \\ 0 & 0 \\ 0 & 0\end{matrix} ]\end{matrix} \qquad [ Equation 17 ]$$

FC4′ of an equation 18 is a connection adjacency matrix indicating that there is no relation from the basic structure BS1 (output) to the basic structure BS1 (input). As the routing action element has been removed, the word Xᵣ as an element of a start-point word is removed.

$$FC {4}^{′} = \begin{matrix}g \\ \begin{matrix}a \\ b \\ c \\ d\end{matrix} [ \begin{matrix}0 \\ 0 \\ 0 \\ 0\end{matrix} ]\end{matrix} \qquad [ Equation 18 ]$$

FC5′ of an equation 19 is a connection adjacency matrix indicating that there is no relation from the basic structure BS1 (output) to the basic structures BS2 & BS3.

$$FC {5}^{′} = \begin{matrix}g \\ \begin{matrix}e \\ f\end{matrix} [ \begin{matrix}0 \\ 0\end{matrix} ]\end{matrix} \qquad [ Equation 19 ]$$

The adjacency matrix F of the system can be represented by an adjacency matrix F′ of the following equation 20 when the conditions of the routing action elements are replaced and the routing action elements are removed.

$${F}^{′} = [ \begin{matrix}F {1}^{′} & 0 & 0 \\ FC {1}^{′} & F {2}^{′} & 0 \\ FC {2}^{′} & & F {3}^{′}\end{matrix} ] = \begin{matrix}\begin{matrix}a & b & c & d & e & f & g\end{matrix} \\ \begin{matrix}a \\ b \\ c \\ d \\ e \\ f \\ g\end{matrix} [ \begin{matrix}0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 0 & 1 & 1 & 0 & 0 & 0 \\ 0 & 1 & 1 & 1 & 0 & 0 & 0 \\ 0 & 0 & 0 & 0 & 1 & 1 & 0\end{matrix} ]\end{matrix} \qquad [ Equation 20 ]$$

In the above equation, a matrix constituted of F1′, F2′, F3′ and FC1′, FC2′, and 0 (means adjacency matrixes having 0 at all intersection points, which corresponds to FC3′, FC4′, and FC5′) indicates how an adjacency matrix and a connection adjacency matrix of basic structure units are integrated to represent the entire system. Next, on the right side, changing these elements into words, we have an adjacency matrix having a, b, c, d, e, f, and g as elements of the matrix. FIG. 8 more easily shows how F1′, F2′, F3′, FC1′, FC2′, FC3′, FC4′, and FC5′ are integrated to constitute F′. In FIG. 8, a portion 1201 is F1′, a portion 1202 is F2′, a portion 1203 is F3′, a portion 1204 is FC1′, and a portion 1205 is FC2′. In a connection adjacency matrix whose intersection points are all 0, FC3′ is a portion 1206, FC4′ is a portion 1207 and FC5′ is a portion 1208.

Thus, one system that comprises two or more basic structures can be represented as one adjacency matrix by removing the routing action elements.

Next, topological sort is applied to the adjacency matrix of the system to rearrange the programs of the unit words in an optimal order so that value states of all the words can be established by a minimum number of execution times (i.e., generation of all output words is completed). In the adjacency matrix F′, as shown in FIG. 9, intersection points with start-point words having values of 1 are all within a left lower triangle (1601). As disclosed in the Patent Document 5 by the applicant, it means that the words are arranged in an optimal order. Thus, it can be said that the adjacency matrix F′ of the equation 20 has been subjected to topological sort, and a word order has been set to enable completion of generation of output words by a minimum number of execution times if initial values of a state vector of words is provided.

5. Verification of Structure when the Routing Action Element has Been Removed

In this section, it is verified that the adjacency matrix F′ described in the above section, which indicates the structure of the system when the routing action elements has been removed, has the same functional function as that of the adjacency matrix F of the structure before the removal of the routing action element. Hereinafter, a process of obtaining a value of the output word g by providing a word state vector to the adjacency matrix F′ will be described. If values of word state vectors Xₘ have all been established as a result of m times calculation process, F′ can be said to be a function which functions similarly to F. Additionally, it will be verified that the execution of the topological sort will enable completion of generation of output words by the minimum number of execution times. It can be said that the adjacency matrix F′ of the system of the Example 1 can be executed by a minimum number of execution times if a state of a value of an output word g is established by one-round process.

As described above, for the initial values of the word state vectors, all the elements are “null (undecided)”. Thus, a state vector X′ of words to be first provided to F′ is represented by the following equation 21.

$${X}^{′} = \begin{matrix}a \\ b \\ c \\ d \\ e \\ f \\ g\end{matrix} [ \begin{matrix}null \\ null \\ null \\ null \\ null \\ null \\ null\end{matrix} ] \qquad [ Equation 21 ]$$

Calculation processing of multiplying the adjacency matrix F′ (i.e., system of the Example 1) of the equation 20 by the state vector X′ of the equation 21 is executed (i.e., an input is made to the system of the Example 1). A state of value of words changed by F′X′ calculation processing will be described one by one of each end-point word.

(1) Calculation of the End-Point Word a During One-Round Processing of F′1

Calculation of the end-point word a during one-round processing is as follows because a state of value of the X′ is used.

$$\begin{matrix}a = 0 \cdot null + 0 \cdot null + 0 \cdot null + 0 \cdot null + 0 \cdot null + 0 \cdot null + \\ 0 \cdot null \\ = ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of value of the input word a is established, and changed from null to (+1). In other words, a value is established by an input. As a result, a state of value of each word after completion of the word a line during one-round processing is as shown in Table 12 below.

TABLE 12

| | a | b | c | d | e | f | g |
|---|---|---|---|---|---|---|---|
| State of value | +1 | null | null | null | null | null | null |

(2) Calculation of the End-Point Word b During One-Round Processing of F′1

Calculation of the end-point word b during one-round processing is as follows because the state of value of the words of the Table 12 is used.

$$\begin{matrix}b = 0 \cdot ( + 1 ) + 0 \cdot null + 0 \cdot null + 0 \cdot null + 0 \cdot null + 0 \cdot null + \\ 0 \cdot null \\ = ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of value of the input word b is established, and changed from null to (+1). As a result, a state of value of each word after completion of the word b line during one-round processing is as shown in Table 13 below.

TABLE 13

| | a | b | c | d | e | f | g |
|---|---|---|---|---|---|---|---|
| State of value | +1 | +1 | null | null | null | null | null |

(3) Calculation of the End-Point Word c During One-Round Processing of F′1

Calculation of the end-point word c during one-round processing is as follows because the state of value of the words of the Table 13 is used.

$$\begin{matrix}c = 0 \cdot ( + 1 ) + 0 \cdot ( + 1 ) + 0 \cdot null + 0 \cdot null + 0 \cdot null + 0 \cdot null + \\ 0 \cdot null \\ = ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of value of the input word c is established, and changed from null to (+1). As a result, a state of value of each word after completion of the word c line during one-round processing is as shown in Table 14 below.

TABLE 14

| | a | b | c | d | e | f | g |
|---|---|---|---|---|---|---|---|
| State of value | +1 | +1 | +1 | null | null | null | null |

(4) Calculation of the End-Point Word d During One-Round Processing of F′1

Calculation of the end-point word d during one-round processing is as follows because the state of the value of the word of the Table 14 is used.

$$\begin{matrix}d = 0 \cdot ( + 1 ) + 0 \cdot ( + 1 ) + 0 \cdot ( + 1 ) + 0 \cdot null + 0 \cdot null + 0 \cdot null + \\ 0 \cdot null \\ = ( + 1 ) + ( + 1 ) + ( + 1 ) + ( + 1 ) + ( + 1 ) + ( + 1 ) + ( + 1 ) \\ = ( + 1 )\end{matrix}$$

As it has no start-point word, a state of value of the input word d is established, and changed from null to (+1). As a result, a state of value of each word after completion of the word d line during one-round processing is as shown in Table 15 below.

TABLE 15

| | a | b | c | d | e | f | g |
|---|---|---|---|---|---|---|---|
| State of value | +1 | +1 | +1 | +1 | null | null | null |

(5) Calculation of the End-Point Word e During One-Round Processing of F′1

Calculation of the end-point word e during one-round processing is as follows because the state of value of the words of the Table 15 is used.

$$\begin{matrix}e = 1 \cdot ( + 1 ) + 0 \cdot ( + 1 ) + 1 \cdot ( + 1 ) + 1 \cdot ( + 1 ) + 0 \cdot ( + 1 ) + 0 \cdot null + \\ 0 \cdot null \\ = ( + 1 ) + ( + 1 ) + ( + 1 ) + ( + 1 ) + ( + 1 ) + ( + 1 ) + ( + 1 ) \\ = ( + 1 )\end{matrix}$$

As the states of the values of the words a, c and d which become start-point words of the word e have been established, a state of value of the word e is changed from null to (+1) to be established. As a result, a state of value of each word after completion of the word e line during one-round processing is as shown in Table 16 below.

TABLE 16

| | a | b | c | d | e | f | g |
|---|---|---|---|---|---|---|---|
| State of value | +1 | +1 | +1 | +1 | +1 | null | null |

(6) Calculation of the End-Point Word f During One-Round Processing of F′1

Calculation of the end-point word f during one-round processing is as follows because the state of value of the words of the Table 16 is used.

$$\begin{matrix}f = 0 \cdot ( + 1 ) + 1 \cdot ( + 1 ) + 1 \cdot ( + 1 ) + 1 \cdot ( + 1 ) + 0 \cdot ( + 1 ) + 0 \cdot null + \\ 0 \cdot null \\ = ( + 1 ) + ( + 1 ) + ( + 1 ) + ( + 1 ) + ( + 1 ) + ( + 1 ) + ( + 1 ) \\ = ( + 1 )\end{matrix}$$

As the states of value of the words b, c, and d which become start-point words of the word f have been established, a state of value of the word f is changed from null to (+1) to be established. As a result, a state of value of each word after completion of the word f line during one-round processing is as shown in Table 17 below.

TABLE 17

| | a | b | c | d | e | f | g |
|---|---|---|---|---|---|---|---|
| State of value | +1 | +1 | +1 | +1 | +1 | +1 | null |

(7) Calculation of the End-Point Word g During One-Round Processing of F′1

Calculation of the end-point word g during one-round processing is as follows because the state of value of the words of the Table 17 is used.

$$\begin{matrix}g = 0 \cdot ( + 1 ) + 0 \cdot ( + 1 ) + 0 \cdot ( + 1 ) + 0 \cdot ( + 1 ) + 1 \cdot ( + 1 ) + 1 \cdot ( + 1 ) + \\ 0 \cdot null \\ = ( + 1 ) + ( + 1 ) + ( + 1 ) + ( + 1 ) + ( + 1 ) + ( + 1 ) + ( + 1 ) \\ = ( + 1 )\end{matrix}$$

As the states of value of the words e and f which become start-point words of the word g have been established, a state of value of the word g is changed from null to (+1) to be established. As a result, a state of value of each word after completion of the word g line during one-round processing is as shown in Table 18 below.

TABLE 18

| | a | b | c | d | e | f | g |
|---|---|---|---|---|---|---|---|
| State of value | +1 | +1 | +1 | +1 | +1 | +1 | +1 |

Thus, one round of calculation processing of all the word lines of the adjacency matrix F′ has been finished. Accordingly, the state of the value of the word of the Table 18 becomes a result of the F′X′. A state vector X′₁ of the following equation 22 is a result of the F′X′.

$${X}_{1}^{′} = \begin{matrix}a \\ b \\ c \\ d \\ e \\ f \\ g\end{matrix} [ \begin{matrix}+ 1 \\ + 1 \\ + 1 \\ + 1 \\ + 1 \\ + 1 \\ + 1\end{matrix} ] \qquad [ Equation 22 ]$$

As descried above, in the adjacency matrix F′, the word unit programs are arranged in an optimal order by the topological sort. Thus, values of all the words are established by one-round calculation processing, thereby establishing a value of the output word g.

It can be understood that the adjacency matrix F′, where the routing action element has been removed, by providing an initial value (inputting is executed) to a state vector, can establish the states of value of all the words to generate the value of the output word g as in the case of the adjacency matrix F. Thus, it has been verified that the adjacency matrix F which is the system having the routing action element and the adjacency matrix F1 which is the system having no routing action element have the same processing function as system.

As described above, when an entire system includes plural basic structures, by integrating them and by applying search (e.g., topological sort) to the integrated structure we can provide much better performance in application of autonomous development technology of Lyee® software or the like. However, for example, when the plural basic structures are not integrated and stay divided, performance as equal as that of the present invention cannot be obtained. If order is not optimized by the search technique such as topological sort, performance as equal as that of the present invention cannot be obtained.

6. Reuse of Program

Processing that needs reuse of the program is repeated even if topological sort is executed.

All kinds of programs (algorithms) can be described only by a recursive method. All kinds of programs written in procedural type programming language (e.g., C, java or the like) can be written by a while program which plays the same role as that of the recursive program. This means that the while program can do anything theoretically.

However, a program method based on words cannot use itself as a start-point word. For example, a=a+b cannot be used for the program based on words. It is because a value of a is not changed once decided. Accordingly, recursive use needs an area to temporarily hold the value of a and a method of clearing it. The held value is used as a start point. For this purpose, an area for temporarily holding contents must be provided. This area is called a temporary word. A structure action element (vector of clear) is defined for clearing.

According to the Lyee methodology, an action element is a kind of word having a predicate-structure. A structure of a program code is similar to that of the word. A main difference from the word is that two or more words are simultaneously treated. The meanings of them are an interface to the outside, a routing for control structures or a clearing areas.

Adjacency matrixes of programs (matrixes of all programs) are integrated into one matrix by using divided adjacency matrixes and connection matrixes for changing states only. The connection matrix indicates that words of the other group are used as start-point words. Accordingly, a mathematical model of the program based on words can be used. Thus, all the usual algorithms expressed in procedural type language can be represented by the program structure based on words.

Next, integration of adjacency matrixes by a connection matrix will be described by using (Example 2) as an example of totaling processing which needs a temporary word such as the a=a+b.

### EXAMPLE 2

Values of records x₂, x₆ of certain words of a file are totaled sequentially from a head, and a totaling result is put to words x₃, x₇.

According to the Lyee methodology, as a value cannot be overwritten once decided, description is in a form of x₃=x₁+x₂, and this is reused. x₁ is a word to substitute for a value of x₃. The value of x₃ is transferred to a temporary area x₄ to substitute for x₁ at the time of next reuse. This is called a “temporary word”. FIG. 10 is a directed graph showing the Example 2. The words x₁, x₂, and x₃ are cleared after x₃ is transferred to x₄. Words x₅, x₆ and x₇ are respectively reuses of the words x₁, x₂, and x₇.

An adjacency matrix (one path matrix) of a part of a program reused in FIG. 10 is F1 below.

$$F 1 = \begin{matrix}\begin{matrix}{x}_{1 , 5} & {x}_{2 , 6} & {x}_{3 , 7}\end{matrix} \\ \begin{matrix}{x}_{1 , 5} \\ {x}_{2 , 6} \\ {x}_{3 , 7}\end{matrix} [ \begin{matrix}0 & 0 & 0 \\ 0 & 0 & 0 \\ 1 & 1 & 0\end{matrix} ] \text{:} one path matrix\end{matrix} \qquad [ Equation 23 ]$$

To reuse F1, connection matrixes to integrate F1 and reused F1 are F2 and F3. These have functions of transmitting states. The matrixes show each end-point word use which word as tart-point words.

$$F 2 = {x}_{4} \begin{matrix}{[ 0}^{{x}_{1}} & {0}^{{x}_{2}} & {1 ] \text{:}}^{{x}_{3}}\end{matrix} \begin{matrix}connection matrix from \\ {x}_{1} , {x}_{2} , {x}_{3} to {x}_{4}\end{matrix} \\ F 3 = \begin{matrix}{x}_{4} \\ \begin{matrix}{x}_{5} \\ {x}_{6} \\ {x}_{7}\end{matrix} [ \begin{matrix}1 \\ 0 \\ 0\end{matrix} ] \text{:} connection matrix from {x}_{4} to {x}_{5} , {x}_{6} , {x}_{7}\end{matrix} \qquad [ Equation 24 ]$$

F2 is a connection matrix from x₁, x₂ and x₃ to x₄. F3 is a connection matrix from x₄ to x₅, x₆, and x₇. F2 and F3 are understood respectively as action elements for an output from x₃ to x₄ and an input from x₄ to x₅. An adjacency matrix of the entire program for reusing F1 is F.

$$F = \begin{matrix}\begin{matrix}{x}_{1} & {x}_{2} & {x}_{3} & {x}_{4} & {x}_{5} & {x}_{6} & {x}_{7}\end{matrix} \\ \begin{matrix}{x}_{1} \\ {x}_{2} \\ {x}_{3} \\ {x}_{4} \\ {x}_{5} \\ {x}_{6} \\ {x}_{7}\end{matrix} [ \begin{matrix}0 & 0 & 0 & 0 & 0 & 0 & 0 \\ 0 & 0 & 0 & 0 & 0 & 0 & 0 \\ 1 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 0 & 0 & 0 \\ 0 & 0 & 0 & 0 & 1 & 1 & 0\end{matrix} ] \text{:} entire system matrix\end{matrix} \qquad [ Equation 25 ]$$

The adjacency matrix of the entire program is represented by using a one-round matrix and a connection matrix. Accordingly, it is possible to use the mathematical model of the program based on words. Thus, all the usual algorithms expressed in procedural type programming language can be realized by programming based on words and by its structure.

<Chapter 3: Specific Example Using the Present Invention>

<Mathematical Algorithm of Topological Sort>

Before describing a specific method, we describe one algorithm for applying topological sort to a sequence of elements in a partial order. Lyee specifications are represented as follows in a word system.
x=F(x) (Equation 2-1-3)

Here, functional F is defined as follows.
F(x)(i)=fᵢ(x(1), x(2), . . . , x(n)), i=1, 2, . . . , n (Equation 2-1-2)

B is called a chain when a subset B, that is not an empty set, of an ordered set (A, ≦) is an all-order set under ≦, and called a reverse chain when no binaries of B can be compared. As the number of end points equal to or more than the number of start points defined on the right side is defined by one-round of iteration processing, F is monotonic. Thus, iteration lines generated one after another repeating F is called a chain and represented the following equation.
(F^{k})kεN [Equation 26]

Here, k denotes the number of iteration times. The minimum number of iteration times is a maximum chain size. Generally, a partial order set can be divided into reverse chains by the following theorem.

[Theorem]

When n is a maximum chain size of the partial order set (A, ≦), A is divided into n reverse chains which are elements of each other.

This theorem is proved by mathematical induction. The following can be said when the theorem is applied to all words of the partial order set. That is, all the words are divided into n word sets among which there is no order. A length (size) n of an iteration column (equation 26) denotes a largest among chains obtained from a relation between start and end points of words, i.e., the minimum number of iteration times necessary until synchronization.

The proof of the theorem provides one algorithm which applies topological sort to a sequence of elements of the partial order set when the sequence is provided. That is, A1, A2 are sequentially obtained from an input side until Aₙ₊₁=0 is reached in which Aₙ is a reverse chain, elements of Aₙ are arranged in a proper order, then elements of Aₙ₋₁ are arranged in a proper order, and elements of A₁ are lastly arranged in a proper order, whereby topological sort can be applied in an ascending order. Here, Aₙ is a set of the largest elements. Here, in other words, it is a set of words closest to an output side. If the words thus arranged are executed from A₁ (input side), all the words are established one after another by one-round processing.

1. Method Integrating Divided Structures

Basic structures are integrated into one, and words are rearranged. A program generated by this method has the following structure.

1) A W04 logical element for generating a value is set on W03.

2) The W03 and W04 logical elements are integrated to constitute a word. Equivalent words are integrated into one word.

3) Words of all basic structures are set on the W4 of a start screen. At this time, execution conditions of routing action elements are spread on the words. The routing action elements are not spread.

4) For all the words and the input/output operation elements, a relation between a start point and a basic element is represented by a directed graph, and topological sort is applied by the aforementioned method to decide an order and to arrange them. Iteration in a palette is not set because it is not necessary. Clearing of a palette area is not set because it is not necessary.

5) A flag of a control area and flags of the input/output operation elements need to be cleared, and thus are left as they are.

As a result,

1) the words and the input/output operation elements belonging to the same basic structure have the same execution conditions because the execution conditions of the routing action elements of the basic structure are equally spread, and thus a group is created after the sort.

2) Consequently, basic elements are regrouped by the route execution conditions, and the basic elements of the group are arranged in an execution order.

2. Specification of an Example

Requirements of this example concern a case of a student grade management system. According to the system, a person of general secretaries registers a student name, and teachers register results of tests, whereby total evaluation can be registered at the end of term. This system comprises three screens of an “initial screen” shown in FIG. 11, a “student registration screen” shown in FIG. 12, and a “result administration screen” shown in FIG. 13, and four files of an “ID & password file” registering ID's and passwords of managers and teachers, a “student name file” registering student names and ID, a “test result file” registering results of tests for each student, and a “total score file” registering term-end total score for each student.

The initial screen is a screen displayed when the result administration system is started. The system is finished by pressing an Exit button. When inputs are made to a field of an ID and a password, and an OK button is pressed, the system refers (reads) to input data and data registered in the ID & password file, and determines whether the input data is a general secretary person's or a teacher's, or belong to neither. If a result of the determination shows that the ID and the password is a manager's, the student registration screen is displayed, the result administration screen is displayed if it is a teacher's, and the initial screen is displayed if they belong to neither.

The student registration screen is a screen on which the person of the general secretaries register student names and student ID numbers. It is a screen displayed when the ID and the password determined on the initial screen is a general secretary person's. During displaying, the system refers to the student name file, and displays data of a registered student in a field of a list of students. After the displaying of the screen, a student name and a student ID number are input to a field of new registration, and input data are registered (written) in the student name file by pressing a registration button. Pressing of a return button enables return to the initial screen.

The result administration screen is a screen for registering and referring to results of tests and total score of each student. It is displayed when the ID and the password determined on the initial screen is a teacher's. During screen displayed, the system refers to the student name file, and prepares lists of student names and student ID numbers of the accessing teacher's as selection candidate lists to be displayed in text boxes of student names. When the person of the general secretary presses a right-end button of the text box to display the student name list, and selects (inputs) a student name and an ID number to be referred to, the system refers to the test result file to calculate and display test results of the input student and an average point of the test results. If total score has been registered, the system simultaneously refers to the total score file to display the total evaluation. To register a new test result, data of a selected student is input to the test result registration field, and the registration button is pressed. The system registers the new data in the test grade file, simultaneously updates and displays contents of the test result field to contents containing the new data, and recalculates and displays an average point. To register total score, total score of the selected student is input to a total score registration field, and the registration button is pressed. The system registers data of the total score in a total evaluation file, and simultaneously displays the data registered in the total evaluation field. The system can return to the initial screen by pressing the return button.

FIG. 14 is a process route diagram showing requirements of the result administration program, and in this case the program is divided into conventional basic structures.

Partial iteration of the same processing to display a list of test results for one student, or the like, and totaling calculation for obtaining an average point are included, and the aforementioned basic processing operations are all included.

3. Implementing Procedure of Case

A language to be used is C++, a function of C++ is used only for a screen part, and the rest is described only by a C grammar. A database management system is Access 97 with DOA.

At the time of designing, requirements divided into nine basic structures were implemented in an integrated form of one basic structure. For program generation, by using LyeeAll2 (automatic code generation tool of Lyee structure program), its template (form of basic element and control program) was changed to automatically generate codes of a basic structure integrated type Lyee program. FIG. 15 shows a part of the new integrated type program code. A 7-th line of the new program indicates route execution conditions, i.e., execution conditions in process definition, and basic elements are accordingly grouped again. The basic elements in the W02 palette are arranged in an order after sort. For words, generation equations alone remain indicated in 11 to 14-th lines.

Comparison of the Lyee structure program generated in the divided basic structure with the new program by the Lyee methodology is as follows. The number of steps of the execution and time are in the case of a program of a requirement “one is selected from 7 students, and results of 5 tests are displayed”. A CPU processing time does not include access time of a database, and a total process time is a total time including the access time of the database. A processing time was obtained as a difference between a start and an end by adding a timestamp function to the program.

4. Result and Evaluation

1) Result

TABLE 19

| | Conventional Lyee | Invention applied | |
|---|---|---|---|
| | structure program | Lyee program | |
| Number of program | 213,559 lines | 6,889 lines | 31% |
| lines | | | |
| CPU process time | 150 msec | 25 msec | 15% |
| Total process time | 470 msec | 345 msec | 73% |

A reduction in execution codes is caused by a small word structure and one basic structure. Main changes are as follows.

1. A predicate-structure comprises about 21 lines. This usually becomes a generation equation alone which comprises one substitution equation line.

2. W03 generation conditions and a W04 generation equation are integrated into one.

3. For action elements, routing action elements constitute one IF sentence. Input/output operation elements remain almost as they are.

4. 80% of clearing action elements is removed.

5. One basic structure needs about 24 KB excluding words and operation elements. In this case, 9 basic structures are integrated into one.

Reductions in number of execution steps and execution time are mainly caused by a reduction in iteration. Main changes are as follows.

1. All the palettes are iterated at least twice, and the basic structures are iterated at least three times. These numbers of times become one.

2. The program code is reduced by 31%.

3. However, the total process time is not reduced so much. It is because the access time of the database is predominant.

4. In real-time processing that does not use database processing, for example, in process control of a building monitoring system, a CPU time is predominant. Accordingly, the new method is very advantageous in size and processing time of the program in the case of process control.

2) Evaluation

As compared with the program based on the conventional structure type programming, the following can be said. At present, problems remain in the program by the conventional structure type programming based on the specification, and the conventional method is limited to qualitative comparison because it depends on programmer's skills.

1) Designing of Program

Execution conditions of words can be understood as action execution conditions of process definition, whereby designing difficulties of the conventional Lyee methodology are reduced. Understanding of specification in a declarative form which is an advantage of the Lyee methodology is realized by process definition and word definition in the new program. Thus, in the new program, as a control procedure is realized by the process definition, program designing is not necessary. According to the conventional method, certain designing is necessary based on specifications.

2) Size of Program

As compared with the program by the conventional structure type programming, in the new program, there are no codes apparently increased in structure.

3) Execution Speed

According to the new program, the number of iteration times is limited to a necessary minimum. Thus, there is no reason for a lower execution speed as compared with the conventional program.

<Chapter 4: Conclusion>

In the present circumstances, according to the program generated by a tool based on the Lyee methodology, specifications divided at the time of designing are developed into program modules in the divided state. Use of information regarding an order explicitly expressed in the requirements is surely effective for improving designing accuracy and efficiency. However, according to the program of the Lyee structure, problems that can be statically solved before execution are dynamically solved during the execution. Thus, a code size is large, and a processing speed is low. There is accordingly room for improvement. A program can be generated without changing its meaning and without dividing basic structures from the start while utilizing the effects of efficient designing. Accordingly, all the words are integrated into one area. Thus, when a correct order is decided among all the words by topological sort in a directed graph of the word relation, iteration for securing ordinality is made unnecessary (see Patent Document 6).

Thus, designing a process route diagram, i.e., dividing requirements, is very useful for accurately understanding the system requirements. The designing the route process diagram means that words having common elements in output conditions are regarded as logical record units. Allocation of the common elements of the conditions to the routing action elements is a great advantage for efficiently defining user requirements.

Additionally, at the time of generating a program code and executing the program, integration of systems divided into basic structures is useful. It is because word unit programs of the entire system can be arranged in an execution order so that it can complete generation of output words by a minimum number of execution times.

As described above, in the system that comprises declaration execution modules of word units, processing of the declaration execution modules for generating output data is completed by eliminating useless iteration and by a minimum number of execution times, and the task of reducing a program size is solved by the following means.

1) The entire system is shown in a process route diagram by setting a set (logical body) of words having the same output conditions as one basic structure. Accordingly, it is possible to accurately understand execution conditions (conditions for the routing actin element to specify the basic structure) common to the declaration execution belonging to the same basic structure.

2) The routing action element is a target of topological sort, and requirements thereof are defined by a word relation as in the case of logical elements defining a word relation. That is, definition is made as to which basic structure to be executed is specified (definition equation) under established conditions (execution conditions of definition equation).

3) The routing action element is removed by adding the definition equation execution conditions of the routing action element to the execution conditions of the modules belonging to the basic structure specified by the routing action element when the conditions are established. By setting the execution conditions of the routing action element on the execution conditions of the modules of the specified basic structure, linkage among the basic structures (i.e., linkage among the words) is established even after the routing action element is removed. Thus, it is possible to integrate all the programs into one.

The declaration execution modules are rearranged in an optimal order by applying topological sort for the declaration execution modules (not including the routing action element) of all the programs thus integrated into one. Accordingly, it is possible to execute the program by avoiding useless iteration and by a minimum number of execution times.

The present invention is not limited to the aforementioned embodiment and examples. Various changes can be made within the scope of technical ideas of the invention. For example, the invention can be realized as a business method, software development device, a software development support device, software for realizing such function by a computer, or a recording medium/dedicated machine having the software mounted therein. Moreover, as described above, needless to say, the present invention can be realized by a method, software having its function, a device/tool (including software itself) having the software mounted therein, or a system.

For example, FIG. 16 is a functional block diagram showing a configuration disposed when the present invention is implemented as one of a program (software) for generating “development target software”, a program generator, a program processor, a tool (including both device and software), a software development device, a software development support device, and a software development management device according to a different embodiment of the invention.

The overall control section 1601 has a function of executing overall operation control, timing control, input/output control or the like of the program (software), the program generator, the program processor, the tool (including both device and software), the software development device, the software support device, or the software development management device, and it is realized as a dedicated chip/circuit having the function, software (including software as a tool) for causing a computer to execute the function, a recording medium recording the software, or a processor/management device/tool having the recording medium mounted thereon.

FIG. 17 is a flowchart showing an operation of the present invention implemented as one of the program (software), the program generator, the program processor, the tool (including both device and software), the software development device, the software support device, and the software development management device having the aforementioned configuration.

Explanation for the both figures is omitted.

Thus, according to the present invention having the aforementioned configuration, in the program that comprises the declaration execution modules of word units, processing of the declaration execution modules for generating output data can be completed by avoiding useless iteration and by a minimum number of execution times, and the program size can be reduced.

According to the different embodiment of the present invention, each of a program (software) for generating “development target software”, a program generator, a program processor, a tool (including both a device and software), a software development device, a software development support device, and a software development management device can be configured by comprising: means for defining, based on user requirements implemented as one program, all necessary declaration execution units to satisfy the requirements that are L2 processing (attribute check processing of input word), L processing (value generation processing of output word), I2 processing (logical record input processing), and O4 processing (logical record output processing), which are decided from declarations by the word being composed of a word name, a definition equation, execution conditions of the definition equation, input/output attribute, and attributes of word value and by the logical record of the word with access conditions; means for defining a (partial) order relation among all the defined L2 processing, L processing, I2 processing, and O4 processing; means for applying topological sort to the L2 processing, L processing, I2 processing, and O4 processing for which the (partial) order relation is defined in the second step; and means for arranging a predetermined code sequence of the declaration execution unit based on Lyee methodology in accordance with an order of the declaration execution units rearranged in the third step.

Furthermore, the present invention is realized by the software produced by the aforementioned “method of generating development target software”, and a recording medium having the software mounted thereon, or a device (hardware) having the software mounted thereon. In this case, the present invention can be configured as a code sequence based on the Lyee methodology in accordance of declaration units with an order rearranged by topological sort applied based on a (partial) order relation defined from the requirements declared by the word units, where declaration execution units, for user requirements mounted as one program, of all necessary for satisfying the requirements, i.e., L2 processing (attribute check processing of input word), L processing (value generation processing of output word), I2 processing (logical record input processing), and O4 processing (logical record output processing), which are decided from declarations by the word being comprised of a word name, a definition equation, execution conditions of the definition equation, input/output attribute, and attributes of a word value and by the logical record of the words with access conditions.

The present invention is realized as software as a form of a software code used for producing the software by the aforementioned “method of generating development target software”, and a recording medium having the software mounted thereon or a device (hardware) having the software mounted thereon.

Furthermore, the present invention can be realized as an extraction method of information (document (paper, data)) extracted from the requirements by the aforementioned “method of generating development target software), the information (document (paper, data)) extracted by the extraction method, a method of using the extracted information, an information recording medium having such information mounted therein, software having the coded information extraction method/using method, a recording medium/device (hardware) having the software mounted thereon, or information extracted from software development requirements having correlated pieces of information to enable realization of such.

According to the invention, many changes and modifications can be made by those who have usual knowledge in the technical field. Thus, the invention should not be limited to the configurations or the operations strictly described with reference to the drawings. Accordingly, proper changes and equivalents can all be within the scope of the invention. The invention has been described in detail by way of specific embodiment and example. However, many modifications, substitutions, and changes can be made without departing not only from the scope of claims of the invention but also from the scope of the invention defined in all the disclosed items.

The application of the invention should not be limited to the foregoing description or explanation, or specific appreciation or combinations of the shown elements. Other embodiments are possible, and the invention can be used and implemented by various methods. Moreover, the terms and the phrases used here are only descriptive but not limitative.

Thus, as easily understood by those who have usual knowledge in the technical field, the disclosed basic concept can be easily used as a basis for designing other structures, methods and systems for implementing some objects of the invention. Accordingly, such equivalent appreciation is within the scope of the claims of the invention as long as it does not depart from the gist and the scope of the invention.

The method of realizing the idea of the invention has been described in detail in the order of the directed graph representation, the adjacency matrix calculation, the topological sort, and the rearrangement. However, these are not absolutely essential elements. For example, the idea of the invention may be realized directly in an order of adjacency matrix calculation→topological sort→rearrangement without executing directed graph representation.

Additionally, rearrangement may be made by combining various search methods such as breadth-first search, iterative deeping, heuristic search, hill climbing, best-first search, Euler's single stroke of a brush, Dijkstra method, and the like with the directed graph.

Alternatively, the basic idea of the invention may be realized by combining such various search methods after the adjacency matrix calculation.

Needless to say, the technical idea of the invention can be realized and used as e.g., an automatic development device, an automatic development program of computer software, or a recording medium, a transmission medium, or a paper medium recording the automatic development program, and in a category of a computer/device on which the automatic development program is mounted, a client server form for executing the automatic development program, or the like.

Furthermore, the present invention is applied not only to a computer system equipped with a single processor, a single hard disk drive, and a single local memory, but also to a system equipped with a plurality of optional or combined processors or memory devices as options of the system. The computer system includes an elaborate calculator, a hand type computer, a laptop/notebook computer, a minicomputer, a main frame computer, a supercomputer, and a processing system network combination thereof. An optional proper processing system that operates in accordance with the principle of the invention may be used instead, or can be used in combination with the above.

Needless to say, the technical idea of the invention can deal with all kinds of programming languages. Moreover, the technical idea of the invention can be applied to all kinds/functions of application software.

According to the invention, various changes, additions, substitutions, expansions, reductions, and the like can be made within similar ideas, equivalents, and the scope of the technical idea. Even when software produced by using the invention is mounted on a secondary product and commercialized, a value of the invention is not reduced.

### INDUSTRIAL APPLICABILITY

According to the present invention thus defined, preprocessing is automatically carried out to avoid iteration, and an object program is mathematically generated by the Lyee® methodology based on the preprocessed word unit program thus obtained. In other words, it is possible to automate a process from sophistication (alignment) of user requirements to generation of an object program. As a result, the invention provides great effects to a software industry, such as great increases in efficiency, productivity, and quality of software production.

### BRIEF DESCRIPTION OF THE DRAWINGS

FIG. 1 are conceptual diagrams explaining a concept of cells according to an embodiment of the present invention.

FIG. 2 is an explanatory diagram of a screen of a system of Example 1 according to the embodiment of the present invention.

FIG. 3 is an explanatory diagram showing words of the system of the Example 1 by basic structure units according to the embodiment of the present invention.

FIG. 4 is a directed graph showing a relation among the words of the system of the Example 1 according to the embodiment of the present invention.

FIG. 5 is a diagram explaining a process of representing the entire system of the Example 1 by one adjacency matrix F according to the embodiment of the present invention.

FIG. 6 is a diagram explaining that the adjacency matrix F of the embodiment of the present invention has been subjected to topological sort.

FIG. 7 is a directed graph showing a relation among the words when a route operation element is removed from a structure of the system of the Example 1 according to the embodiment of the present invention.

FIG. 8 is a diagram explaining a process of representing the entire system by one adjacency matrix F′ when the route operation element is removed from the system of the Example 1 according to the embodiment of the present invention.

FIG. 9 is a diagram explaining that the adjacency matrix F′ of the embodiment of the present invention has been subjected to topological sort.

FIG. 10 is a directed graph of Example 2 according to the embodiment of the present invention.

FIG. 11 is a diagram showing an “initial screen” of the Example 2 according to the embodiment of the present invention.

FIG. 12 is a diagram showing a “student registration screen” of the Example 2 according to the embodiment of the present invention.

FIG. 13 is a diagram showing a “grade management screen” of the Example 2 according to the embodiment of the present invention.

FIG. 14 is a process route diagram showing a structure in which requirements of a grade management program of the Example 2 of the embodiment of the present invention and this program are divided into conventional basic structures.

FIG. 15 shows a part of an integrated type new program code according to the embodiment of the present invention.

FIG. 16 is a functional block diagram showing a configuration of functions provided when the present invention is implemented as one selected from a program (software) for producing “development target software”, a program generation device, a program processor, a tool (including both of a device and software), a software development device, a software development support device, and a software development management device according to a different embodiment of the present invention.

FIG. 17 is a flowchart showing an operation of the present invention implemented as one selected from the program (software), the program generation device, the program processor, the tool (including both a device and software), the software development device, the software development support device, and the software development management device, which has the above configuration according to the embodiment of the present invention.

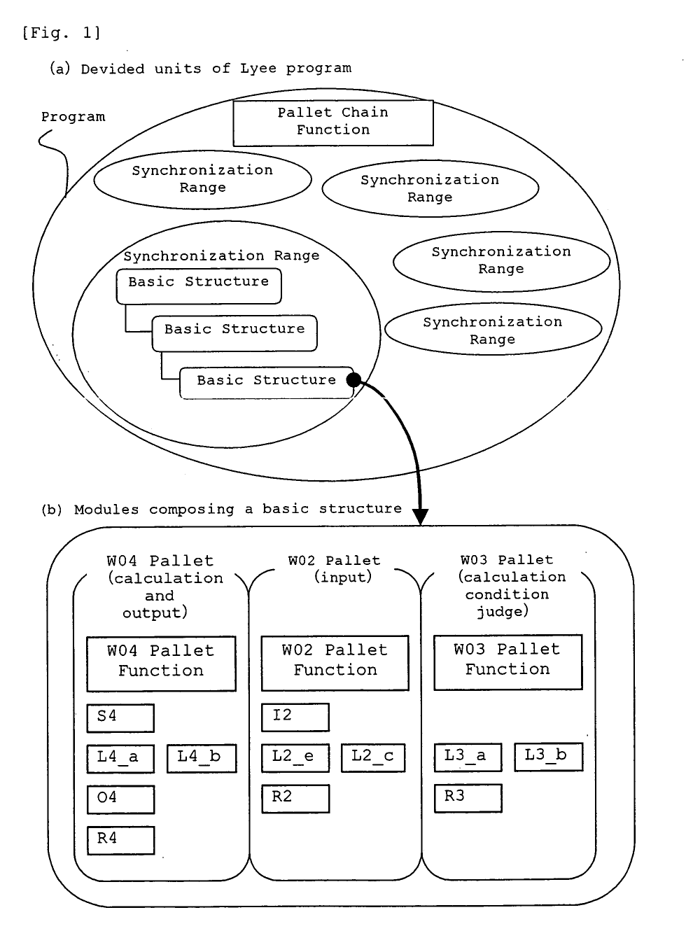

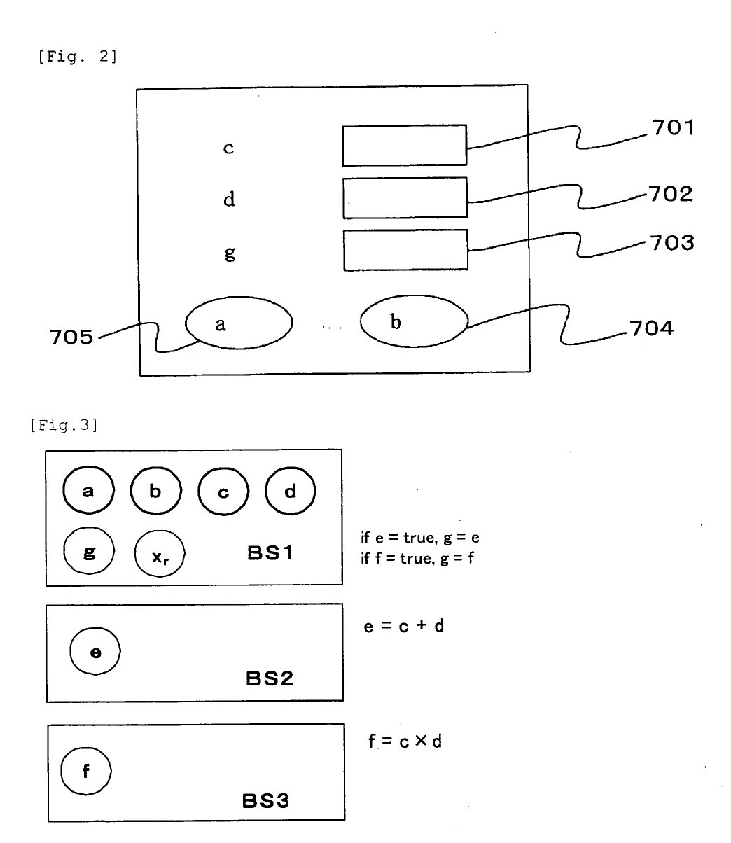

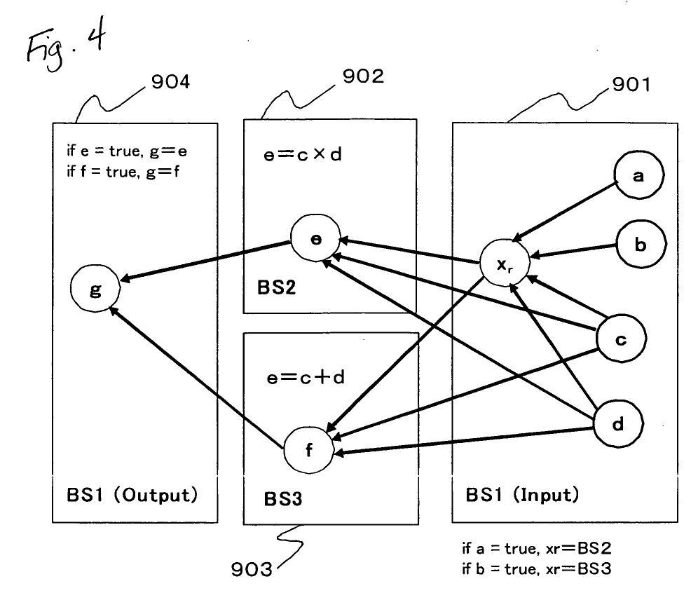

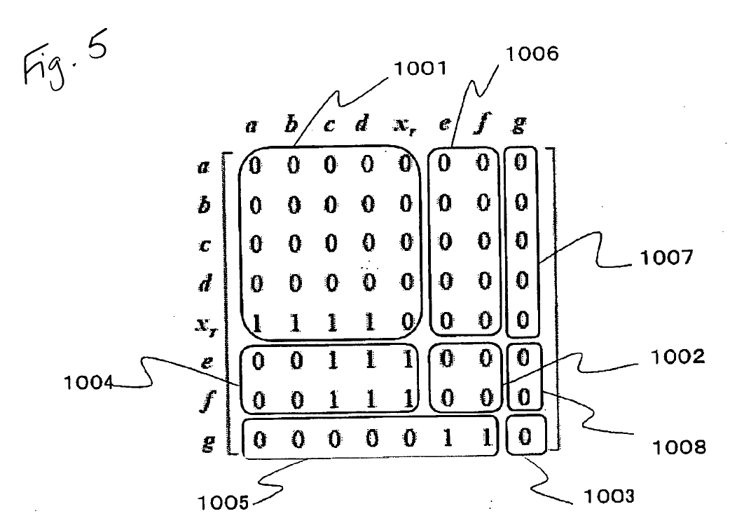

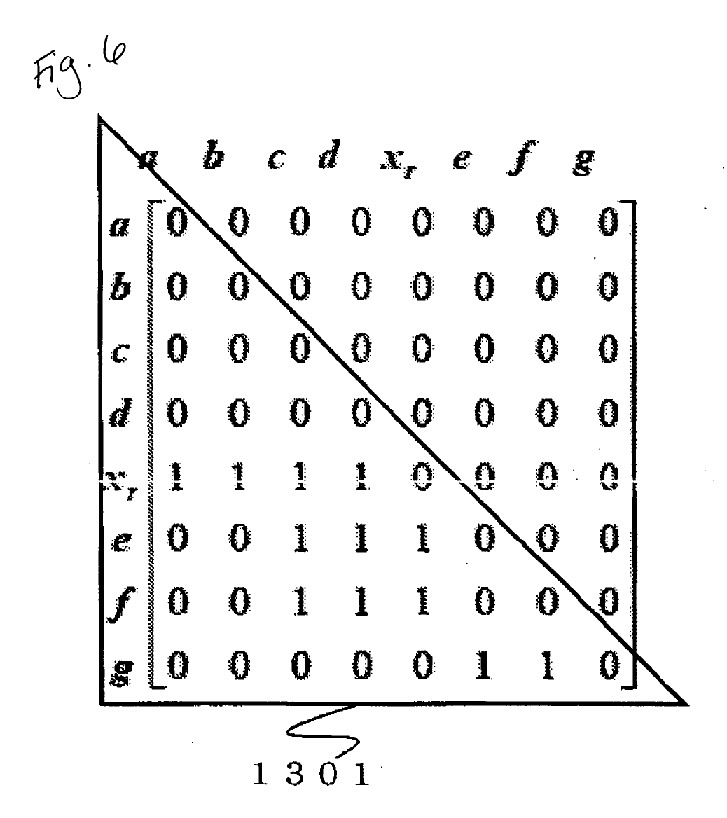

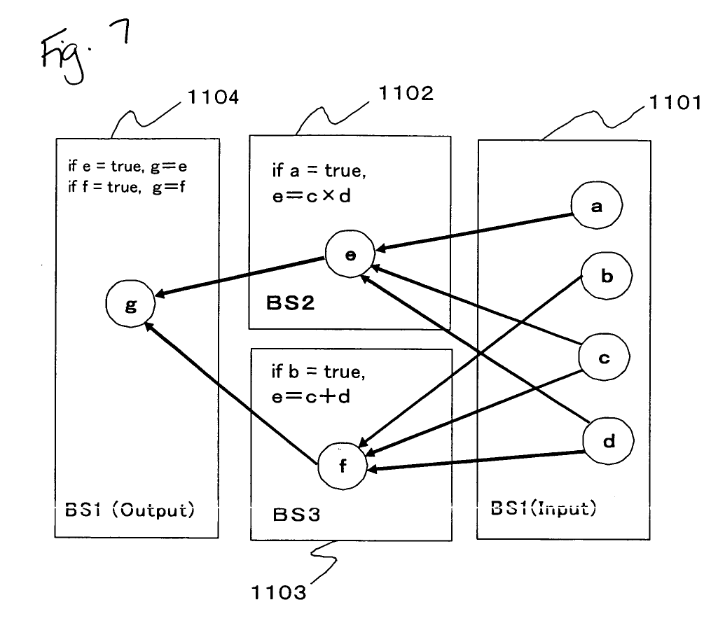

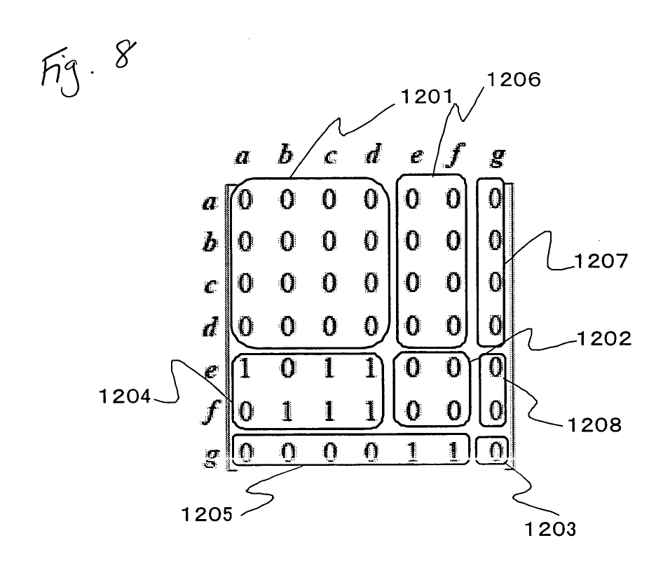

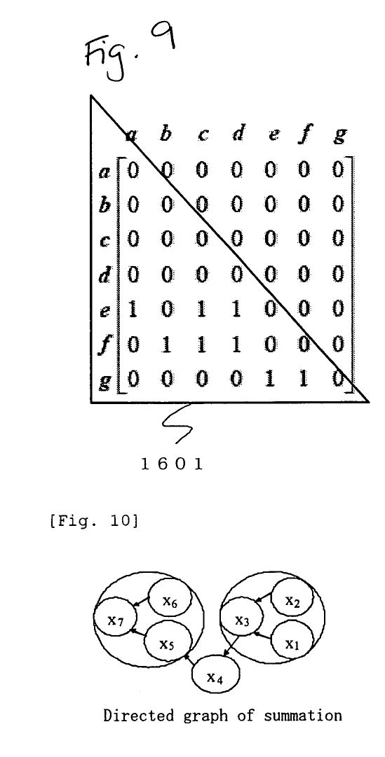

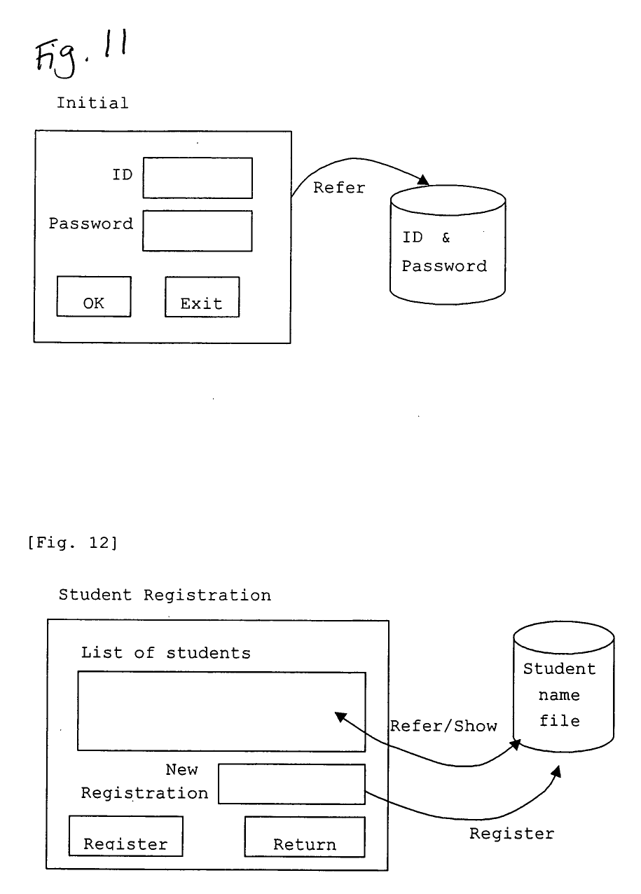

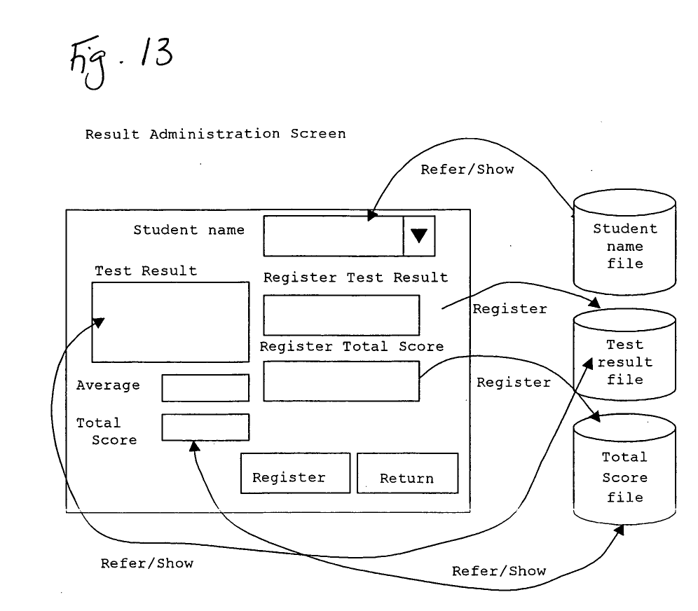

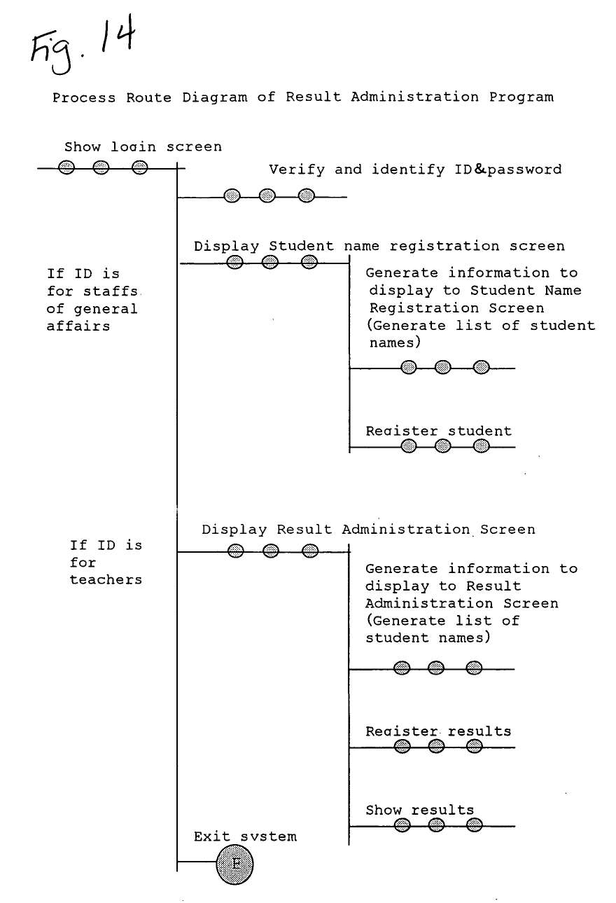

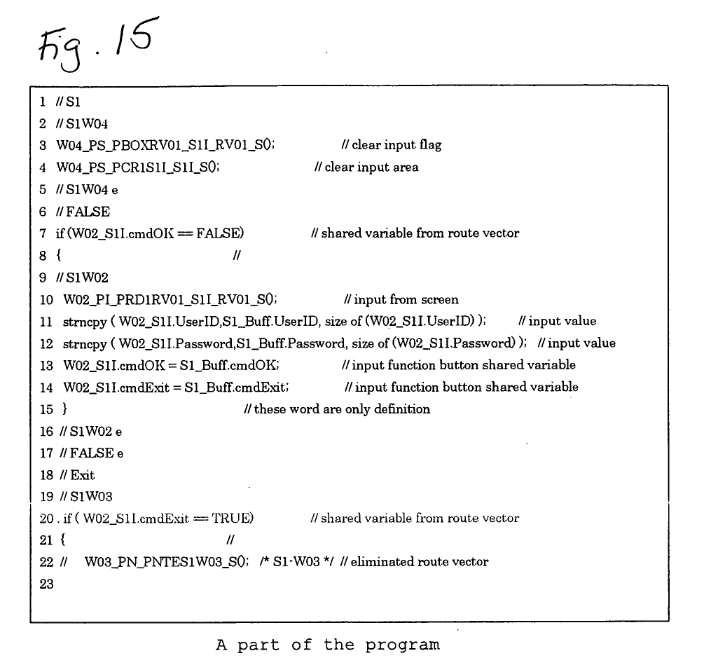

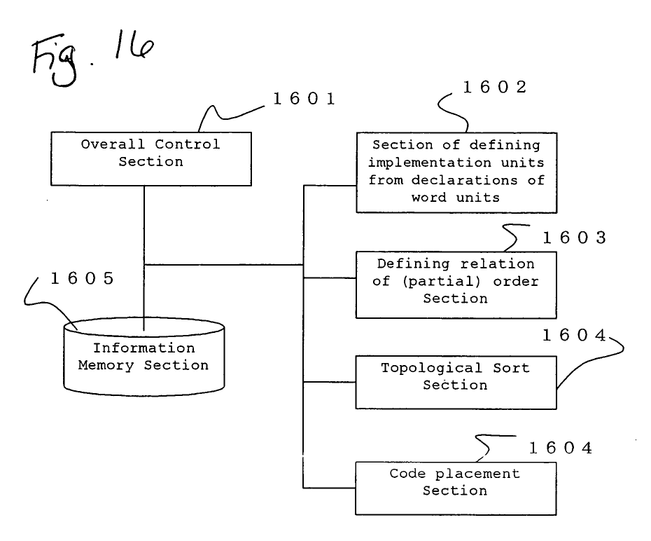

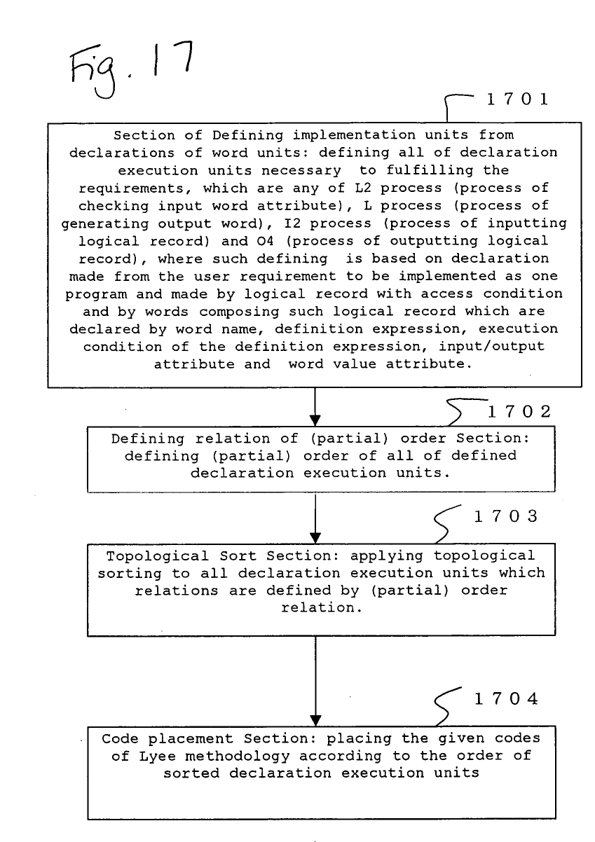

### DESCRIPTION OF SYMBOLS

101 Synchoronization
1101 Basic Structure BS1 (Input)
1102 Basic Structure BS2
1103 Basic Structure BS3
1104 Basic Structure BS1 (Output)
1201 Adjacency Matrix F1′
1202 Adjacency Matrix F2′
1203 Adjacency Matrix F3′
1204 Connection Matrix FC1′
1205 Connection Matrix FC2′

1. Software generation method characterized by comprising:
a first step for defining a statement execution unit of any of L2 processing (checking process for input word's attribute), L processing (value generation processing of output word), I2 processing (logical body input processing), and O4 processing (logical body output processing), all of which are necessary for satisfying the requirements, from word-unit statements in which the user requirements to be implemented as a program is declared by a word name, a definition equation, execution conditions of the definition equation, input/output attributes, and attributes of a word value for each logical body accompanied by access conditions and for each word on the logical body;
a second step for defining a (partial) order relation of all said defined L2 processing (checking process for input word's attribute), L processing (value generation processing of output word), I2 processing (logical body input processing), and O4 processing (logical body output processing);
a third step for executing topological sort for said L2 processing, L processing, I2 processing, and O4 processing defined in the (partial) order relation defined in the second step; and
a fourth step for arranging a predetermined code sequence based on Lyee methodology and relevant to the statement execution unit in accordance with an order of the statement execution units rearranged in the third step.
